(19) United States
(12) Patent Application Publication
(10) Pub. No.: US 2015/0049260 A1
(43) Pub. Date: Feb. 19, 2015

(54) COLOR FILTER-INTEGRATED TOUCH PANEL

(71) Applicant: Sharp Kabushiki Kaisha, Osaka (JP)

(72) Inventors: Yuhji Yashiro, Osaka (JP); Hiroyuki Ogawa, Osaka (JP); Kazutoshi Kida, Osaka (JP); Yasuhiro Sugita, Osaka (JP)

(73) Assignee: Sharp Kabushiki Kaisha, Osaka (JP)

(21) Appl. No.: 14/385,759

(22) PCT Filed: Mar. 11, 2013
(86) PCT No.: PCT/JP2013/056584

§ 371 Date: Sep. 16, 2014

(30) Foreign Application Priority Data
Mar. 22, 2012 (JP) 2012-066189

(51) Int. Cl. G02F 1/1335; H05B 33/12; H01J 17/49; G06F 3/044; G02F 1/1333

(52) U.S. Cl. CPC G02F 1/133514; G06F 3/044; G02F 1/13338; H01J 17/49; H05B 33/12
USPC 349/12

(57) ABSTRACT

A large-screen capacitive touch panel integrated with a color filter that can be applied to a large-screen display device is provided. The color filter-integrated touch panel includes mesh detection electrodes constituted of a large number of meshes, mesh driving electrodes constituted of a large number of meshes, and floating electrodes. The floating electrodes are disposed between a display device, which will be used after being combined with the color filter-integrated touch panel, and the detection electrodes and driving electrodes. The floating electrodes suppress the display device from adversely affecting the touch panel by being between the display device and the detection electrodes and driving electrodes.

### TECHNICAL FIELD

The present invention is directed to a touch panel, and more particularly, towards a color filter-integrated touch panel in which a color filter has been integrally formed with a touch panel for use in a liquid crystal display device or the like.

### BACKGROUND ART

Touch panels are becoming widespread for electronic devices such as mobile phones, car navigation systems, personal computers, and terminals or the like at banks, for example. A touch location (contact location) is inputted to these touch panels when a finger, pen tip, or the like makes contact with the touch panel while an image is shown on a display screen constituted of a liquid crystal display panel or the like. Various types of touch panels are being proposed based on detection principles for detecting touch location, but it is preferable to have a capacitive touch panel that has a simple mechanism and that can be made cheaply in a relatively large size. In particular, in-cell capacitive touch panels, which have the touch panel function embedded in the liquid crystal display device, have been gaining attention due to greatly contributing to lowering manufacturing costs and making devices thinner.

Patent Document 1 discloses a color filter-integrated touch panel in which touch location detecting electrodes are integrally provided with color filters in a liquid crystal display panel. FIG. 24 shows the basics of the color filter-integrated touch panel disclosed in Patent Document 1.

In FIG. 24, a black matrix is formed on a CF plate 5703, and an ITO1 layer 5701 for detecting touch location is formed on this CF plate 5703. An ITO2 layer 5702 is also formed on the CF plate 5703 through color filters and a planarizing layer. This ITO2 layer 5702 is used for applying common voltage during driving of an LCD device, and is used as a touch driving electrode when the LCD is not being driven.

The conventional example shown in FIG. 24 is a capacitive touch panel for detecting touch location and is formed in integration with the color filters on the color filter substrate, which makes it possible to realize a liquid crystal display device with a compact touch panel attached thereto. In other words, it is not necessary for the touch panel to be a separate component.

Patent Document 2 discloses a capacitive touch panel in which touch location detecting electrodes are disposed on the color filter substrate and formed in integration with the color filters, in a manner similar to Patent Document 1. FIG. 25 shows the basics of the color filter-integrated touch panel disclosed in Patent Document 2.

In FIG. 25, reference character 50 shows a touch panel-integrated color filter in which touch location detecting electrodes 60 and 70 have been formed in integration therewith. The touch panel-integrated color filter 50 includes a base material 52, a “color filter layer 54 having a plurality of colored portions 56” formed on the base material 52, and the electrode 60 disposed between the color filter layer 54 and the base material 52. The electrode 70 is disposed on the side of the electrode 60 opposite to the base material 52 through an insulating layer 67, and the electrodes 60 and 70 are electrically connected to a circuit for detecting touch location of a fingertip or the like on the display surface, which is on the viewer's side.

In a manner similar to the conventional example shown in FIG. 24, the conventional example shown in FIG. 25 is a touch panel for detecting touch location and is formed in integration with the color filters on the color filter substrate, which makes it possible to realize a liquid crystal display device with a compact touch panel attached thereto. In other words, it is not necessary for the touch panel to be a separate component.

Patent Document 2 also suggests that the touch location detecting electrodes 60 and 70 can be constituted of a metal layer patterned in a mesh shape or a metal film patterned in a stripe shape.

### RELATED ART DOCUMENTS

### Patent Documents

Patent Document 1: Japanese Translation of PCT International Application Publication No. 2009-540374 (Published Nov. 19, 2009)

Patent Document 2: Japanese Patent Application Laid-Open Publication No. 2010-72581 (Published Jul. 2, 2010)

### SUMMARY OF THE INVENTION

### Problems to be Solved by the Invention

According to the inventions disclosed in Patent Document 1 and Patent Document 2, it is possible to obtain a liquid crystal display device (in-cell capacitive touch panel) having a compact touch panel, in which the touch panel for touch location detection is formed in integration with color filters on the color filter substrate.

However, in the color filter-integrated touch panels (or touch panel-integrated color filter) in which the color filters and touch panel are integrated together in Patent Documents 1 and 2, there is no particular configuration to deal with problems occurring due to interaction among the electrodes forming the touch panel, the driving electrodes of the liquid crystal display device and the like, and the common driving electrode. Examples of these problems include touch panel malfunction due to noise during driving of the liquid crystal display device, and signal degradation due to coupling of the common liquid crystal electrode of the liquid crystal display device and the touch location detecting electrodes. As such, it is difficult to achieve a touch panel with stable operation using these configurations.

Furthermore, in the technology disclosed in Patent Document 1, when the surface area of the touch panel is increased to a large size, the capacitive components of the circuit portion of the touch panel greatly increase, and the resistance of the transparent electrode such as ITO forming a portion of the touch panel also increases. These factors together cause the time constant of the circuits to increase and make it difficult to realize a large surface area touch panel with a practical operating speed.

In other words, when a capacitive touch panel is integrated with a display device having a surface area that is larger than a mobile phone, tablet PC, and the like (when using an in-cell capacitive touch panel), it is not possible to attain a sufficient SN ratio for touch location detection due to being unable to achieve a sufficient integral network because of the increase of the RC time constant.

Patent Document 2 also suggests that, in order to lower capacitance, the detection electrodes and driving electrodes be made of a metal layer patterned in a mesh shape or a metal layer patterned in a stripe shape. As will be explained using FIG. 2 later, however, this causes signal degradation by the coupling of the display driving circuits of the liquid crystal display device or the like and the detection electrodes and driving electrodes, which will all be used simultaneously. Therefore, in this case it is not possible to achieve sufficiently powerful detection signals.

Patent Document 2 describes a shield layer 75 being provided, but ordinarily, when a voltage is applied to the driving electrodes in a capacitive touch panel, an electric flux occurs from the driving electrodes to the detection electrodes, and this electric flux increases and decreases regardless of touch, thereby increasing and decreasing the capacitance between the driving electrodes and the detection electrodes and acting as a signal. Accordingly, when shielding electrodes are disposed directly below the driving electrodes, a large portion of the electric flux generated by the driving electrodes is absorbed by the shielding electrodes, and the electric flux ceases to contribute to the signal.

### Means for Solving the Problems

To solve the above-mentioned problems, in one aspect, the present invention provides a color filter-integrated touch panel that includes: a substrate; a touch panel component having detection electrodes and driving electrodes for touch location detection disposed on the substrate; and a color filter formed on the touch panel component, the color filter making multicolor display possible after being combined with a display device, wherein the detection electrodes and the driving electrodes of the touch panel component are insulated from each other and are mesh-shaped electrodes formed from a plurality of meshes, wherein mesh-shaped floating electrodes formed from a plurality of meshes are disposed between the color filter and the touch panel component having the detection electrodes and the driving electrodes, the floating electrodes being electrically insulated from the detection electrodes and the driving electrodes, and wherein the floating electrodes center around the driving electrodes and respectively overlaps the driving electrode and the detection electrodes adjacent thereto.

With this configuration, the detection electrodes and the driving electrodes for touch location detection on the touch panel component are all mesh electrodes constituted of a plurality of meshes; thus, it is possible to significantly reduce the capacitance of the circuits for touch location detection, which allows the touch panel to have a larger surface area. Floating electrodes are disposed between the touch panel component and the color filter, and these floating electrodes abut at least the detection electrodes that are adjacent to the area around the driving electrodes with the driving electrodes being at the center of this area; therefore, it is possible to alleviate the electrical coupling of the common electrode with the liquid crystal display device or the like that will be disposed on the color filter side, thereby allowing for a suppression of signal degradation.

To solve the above-mentioned problems, in one aspect, the present invention provides the color filter-integrated touch panel, further including a light-shielding member formed on the color filter close to a viewer at respective edges of the meshes of the detection electrodes, the driving electrodes, and the floating electrodes.

With this configuration, the detection electrodes, driving electrodes, and floating electrodes are disposed corresponding to the location of the shielding section, which does not affect the display, in a plan view. Therefore, there is almost no reduction of display quality of the display device.

To solve the above-mentioned problems, in one aspect, the present invention provides the color filter-integrated touch panel, wherein the light-shielding member is formed at respective edges of sub-pixels in a display device, and wherein the meshes of the detection electrodes and the driving electrodes forming the touch panel component and the meshes of the floating electrodes are formed at the respective edges of the sub-pixels in the display device.

With this configuration, the electrodes are disposed corresponding to the respective edges of the sub-pixels, which traditionally have almost no effect on display; thus, there will be very little reduction in display quality of the display device.

To solve the above-mentioned problems, in one aspect, the present invention provides the color filter-integrated touch panel, wherein the detection electrodes and the driving electrodes of the touch panel component are made of a metal film formed in a first mesh layer, and wherein the floating electrodes are made of a metal film formed in a second mesh layer that is different from the first mesh layer.

With this configuration, the detection electrodes, driving electrodes, and floating electrodes forming the touch panel component are made of a metal film, thus allowing for the resistance of the circuit portions of the respective electrodes to be lowered and for suppression of an increase in the time constant of the circuits. This makes it possible for the touch panel to have a larger surface area. The detection electrodes and the driving electrodes forming the touch panel component are formed in the same layer, and therefore, the formation of these electrodes can be done with one round of metal film deposition and patterning by photolithography, which makes the manufacturing thereof easier.

To solve the above-mentioned problems, in one aspect, the present invention provides the color filter-integrated touch panel, wherein the detection electrodes are rectangular electrodes formed from the plurality of meshes that extend in an X axis direction and a Y axis direction, a plurality of the detection electrodes being electrically connected in the Y axis direction, and wherein the driving electrodes are rectangular electrodes formed from the plurality of meshes that extend in the X axis direction and the Y axis direction, a plurality of the driving electrodes being electrically connected in the X axis direction.

With this configuration, the detection electrodes and the driving electrodes forming the touch panel component are constituted of meshes, which makes it possible to significantly reduce the capacitance of the circuits for touch location detection. This allows for the touch panel to have a larger surface area.

To solve the above-mentioned problems, in one aspect, the present invention provides the color filter-integrated touch panel, wherein the detection electrodes are diamond-shaped electrodes formed from the plurality of meshes that extend in an X axis direction and a Y axis direction, a plurality of the detection electrodes being electrically connected in the Y axis direction, and wherein the driving electrodes are diamond-shaped electrodes formed from the plurality of meshes that extend in the X axis direction and the Y axis direction, a plurality of the driving electrodes being electrically connected in the X axis direction.

With this configuration, the detection electrodes and the driving electrodes forming the touch panel component are constituted of meshes, which makes it possible to significantly reduce the capacitance of the circuits for touch location detection. This allows for the touch panel to have a larger surface area.

To solve the above-mentioned problems, in one aspect, the present invention provides the color filter-integrated touch panel, wherein the touch panel component having the detection electrodes and the driving electrodes is formed under the light-shielding member as seen from a viewing side of the display device.

With this configuration, in addition to being able to increase the surface area of the touch panel, the detection electrodes, driving electrodes, and floating electrodes formed in mesh-shapes are all formed under the black matrix as seen from the viewer's side. Thus, when the detection electrodes, driving electrodes, and floating electrodes are formed of a good conductor such as metal, these electrodes become harder for the viewer to see, for example. Accordingly, when integrated with a display device, it is possible to prevent harming the display quality of the display device.

To solve the above-mentioned problems, in one aspect, the present invention provides the floating electrodes detection electrode metal bridges for connecting the detection electrodes together, the detection electrode metal bridges and the floating electrodes being formed in the second mesh layer, wherein a disconnection width of the floating electrodes and the detection electrode metal bridges is at most one mesh, and wherein the floating electrodes and the detection electrode metal bridges have a light-shielding function.

With this configuration, in addition to being able to increase the surface area of the touch panel, even if the light-shielding member (black matrix) is omitted from the configuration, the floating electrodes and the detection electrode metal bridges, which have had the disconnection portion thereof minimized, function similar to the black matrix. This reduces costs, while making it possible to provide a color filter-integrated touch panel that is suitable for a display device with a large screen size. In this case, the floating electrodes and the detection electrode metal bridges, which are required to have high conductivity, can be formed by one round of metal film deposition and then patterning through photolithography. This makes the manufacturing process easier. This also has the advantage of being able to use a conductive material with high light-shielding effects, such as metallic chromium, titanium, nickel, or the like, for example.

To solve the above-mentioned problems, in one aspect, the present invention provides the color filter-integrated touch panel, wherein the detection electrodes of the touch panel component are made of a metal film formed in a first mesh layer, wherein the floating electrodes are made of a metal film formed in a second mesh layer that is different from the first mesh layer, and wherein the driving electrodes are made of a third mesh layer that is disposed between the first mesh layer and the second mesh layer.

With this configuration, in addition to being able to increase the surface area of the touch panel, it is not necessary to provide the metal bridges of the detection electrodes that are integrally connected to the detection electrodes of the touch panel component, thereby making the process of contact hole forming unnecessary. This allows for an improvement in yield when manufacturing.

To solve the above-mentioned problems, in one aspect, the present invention provides the color filter-integrated touch panel, wherein the floating electrodes formed in the second mesh layer have a disconnection width of at most one mesh, and wherein the floating electrodes have a light-blocking function.

With this configuration, in addition to being able to increase the surface area of the touch panel, even if a black matrix is omitted from this configuration, the floating electrodes that have had the disconnection portion thereof minimized have a function similar to a black matrix; therefore, it is possible to suppress visibility of the electrodes of the touch panel component. Accordingly, it is possible to reduce costs while preventing degradation of display characteristics of the display device.

To solve the above-mentioned problems, in one aspect, the present invention provides the color filter-integrated touch panel, wherein the floating electrodes are electrically insulated in each one node area.

With this configuration, in the floating electrodes interposed between the detection electrodes, driving electrodes, and the common electrode, direct coupling of the common electrode and the driving electrodes by potential being generated therebetween is alleviated, signal strength is increased, and the touch panel can have a larger surface area.

To solve the above-mentioned problems, in one aspect, the present invention provides the color filter-integrated touch panel, wherein the floating electrodes are electrically connected from each line of the detection electrodes.

With this configuration, in the floating electrodes interposed between the detection electrodes, driving electrodes, and the common electrode, direct coupling of the common electrode and the driving electrodes by potential being generated therebetween is alleviated, signal strength is increased, and the touch panel can have a larger surface area.

To solve the above-mentioned problems, in one aspect, the present invention provides the color filter-integrated touch panel, wherein the floating electrodes are electrically connected from each line of the driving electrodes.

With this configuration, in the floating electrodes interposed between the detection electrodes, driving electrodes, and the common electrode, direct coupling of the common electrode and the driving electrodes by potential being generated therebetween is alleviated, signal strength is increased, and the touch panel can have a larger surface area.

To solve the above-mentioned problems, in one aspect, the present invention provides the color filter-integrated touch panel, wherein the floating electrodes are formed on an entire surface of the touch panel component.

With this configuration, in the floating electrodes interposed between the detection electrodes, driving electrodes, and the common electrode, direct coupling of the common electrode and the driving electrodes by potential being generated therebetween is alleviated, signal strength is increased, and the touch panel can have a larger surface area.

To solve the above-mentioned problems, in one aspect, the present invention provides a liquid crystal display device having a color filter-integrated touch panel, the color filter-integrated touch panel fundamentally including: a substrate; a touch panel component having detection electrodes and driving electrodes for touch location detection disposed on the substrate; and a color filter formed on the touch panel component, the color filter making multicolor display possible after being combined with a display device, wherein the detection electrodes and the driving electrodes of the touch panel component are insulated from each other and are mesh-shaped electrodes formed from a plurality of meshes, wherein mesh-shaped floating electrodes formed from a plurality of meshes are disposed between the color filter and the touch panel component having the detection electrodes and the driving electrodes, the floating electrodes being electrically insulated from the detection electrodes and the driving electrodes, and wherein the floating electrodes center around the driving electrodes and respectively overlaps the driving electrode and the detection electrodes adjacent thereto.

With this configuration, it is possible to achieve a liquid crystal display device having a touch panel in which touch location can be detected on the entire surface of a large-sized display screen and in which a reduction in display quality has been minimized.

To solve the above-mentioned problems, in one aspect, the present invention provides a plasma display device having a color filter-integrated touch panel, the color filter-integrated touch panel fundamentally including: a substrate; a touch panel component having detection electrodes and driving electrodes for touch location detection disposed on the substrate; and a color filter formed on the touch panel component, the color filter making multicolor display possible after being combined with a display device, wherein the detection electrodes and the driving electrodes of the touch panel component are insulated from each other and are mesh-shaped electrodes formed from a plurality of meshes, wherein mesh-shaped floating electrodes formed from a plurality of meshes are disposed between the color filter and the touch panel component having the detection electrodes and the driving electrodes, the floating electrodes being electrically insulated from the detection electrodes and the driving electrodes, and wherein the floating electrodes center around the driving electrodes and respectively overlaps the driving electrode and the detection electrodes adjacent thereto.

With this configuration, it is possible to achieve a plasma display device having a touch panel in which touch location can be detected on the entire surface of a large-sized display screen and in which a reduction in display quality has been minimized.

To solve the above-mentioned problems, in one aspect, the present invention provides an electroluminescent display device having a color filter-integrated touch panel, the color filter-integrated touch panel fundamentally including: a substrate; a touch panel component having detection electrodes and driving electrodes for touch location detection disposed on the substrate; and a color filter formed on the touch panel component, the color filter making multicolor display possible after being combined with a display device, wherein the detection electrodes and the driving electrodes of the touch panel component are insulated from each other and are mesh-shaped electrodes formed from a plurality of meshes, wherein mesh-shaped floating electrodes formed from a plurality of meshes are disposed between the color filter and the touch panel component having the detection electrodes and the driving electrodes, the floating electrodes being electrically insulated from the detection electrodes and the driving electrodes, and wherein the floating electrodes center around the driving electrodes and respectively overlaps the driving electrode and the detection electrodes adjacent thereto.

With this configuration, it is possible to achieve an EL display device having a touch panel in which touch location can be detected on the entire surface of a large-sized display screen and in which a reduction in display quality has been minimized.

### Effects of the Invention

As described above, in one aspect, the present invention can provide a large-screen display device having a highly convenient touch panel function in which it is possible to achieve a large-screen touch panel and in which the touch panel of the present invention and various types of large display devices are combined.

### BRIEF DESCRIPTION OF THE DRAWINGS

FIG. 1 is a view for explaining the fundamental configuration of a color filter-integrated touch panel according to the present invention.

FIG. 2 is a view for explaining the effects of the color filter-integrated touch panel of the present invention.

FIG. 3 is a view for explaining a configuration of a color filter-integrated touch panel according to Embodiment 1 of the present invention.

FIG. 4 is a view for explaining the schematic structure of the detection electrodes and driving electrodes in the color filter-integrated touch panel according to Embodiment 1 of the present invention.

FIG. 5 is a view for explaining the detailed structure of the detection electrodes and driving electrodes in the color filter-integrated touch panel according to Embodiment 1 of the present invention.

FIG. 6 is a view for explaining the detailed structure of the detection electrodes and driving electrodes in the color filter-integrated touch panel and the connecting structure (metal bridges) of the detection electrodes, according to Embodiment 1 of the present invention.

FIG. 7 is a view for explaining the configuration of the floating electrodes in the color filter-integrated touch panel according to Embodiment 1 of the present invention.

FIG. 8 is a view for explaining other configurations of the floating electrodes in the color filter-integrated touch panel according to Embodiment 1 of the present invention.

FIG. 9 is a view for explaining a method of manufacturing the color filter-integrated touch panel according to Embodiment 1 of the present invention.

FIG. 10 is a view of the effects of the color filter-integrated touch panel according to Embodiment 1 of the present invention.

FIG. 11 is a view for explaining a schematic structure of detection electrodes and driving electrodes in a color filter-integrated touch panel according to Embodiment 2 of the present invention.

FIG. 12 is a view for explaining the detailed structure of the detection electrodes and driving electrodes in the color filter-integrated touch panel according to Embodiment 2 of the present invention.

FIG. 13 is a view of one example of the electrode size of the detection electrodes and driving electrodes in the color filter-integrated touch panel according to Embodiment 2 of the present invention.

FIG. 14 is a view for explaining the connecting structure (metal bridges) of the detection electrodes in the color filter-integrated touch panel according to Embodiment 2 of the present invention.

FIG. 15 is a view for explaining a configuration of the floating electrodes and the electrode size of the floating electrodes in the color filter-integrated touch panel according to Embodiment 2 of the present invention.

FIG. 16 is a view for explaining other configurations of the floating electrodes in the color filter-integrated touch panel according to Embodiment 2 of the present invention.

FIG. 17 is a view for explaining a configuration of a color filter-integrated touch panel according to Embodiment 3 of the present invention.

FIG. 18 is a view for explaining a configuration of a color filter-integrated touch panel according to Embodiment 4 of the present invention.

FIG. 19 is a view for explaining a configuration of a color filter-integrated touch panel according to Embodiment 5 of the present invention.

FIG. 20 is a view for explaining the configuration of the detection electrodes in the color filter-integrated touch panel according to Embodiment 5 of the present invention.

FIG. 21 is a view for explaining the configuration of the driving electrodes in the color filter-integrated touch panel according to Embodiment 5 of the present invention.

FIG. 22 is a view for explaining the configuration of floating electrodes in the color filter-integrated touch panel according to Embodiment 5 of the present invention.

FIG. 23 is a view for explaining other configurations of the floating electrodes in the color filter-integrated touch panel according to Embodiment 5 of the present invention.

FIG. 24 is a view for explaining a configuration of a conventional touch panel.

FIG. 25 is a view for explaining a configuration of a conventional touch panel.

### DETAILED DESCRIPTION OF EMBODIMENTS

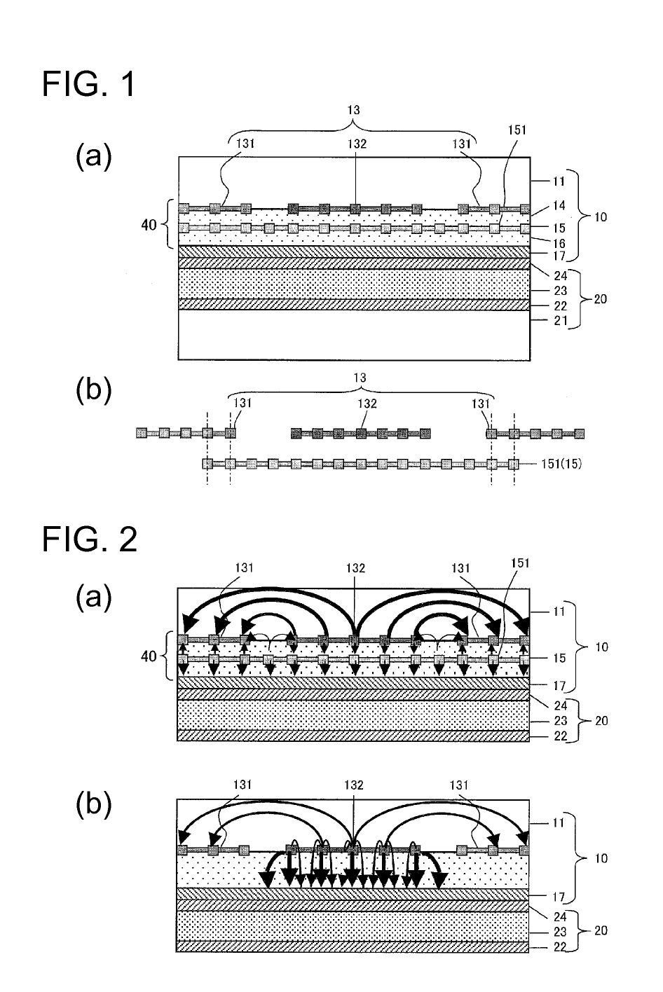

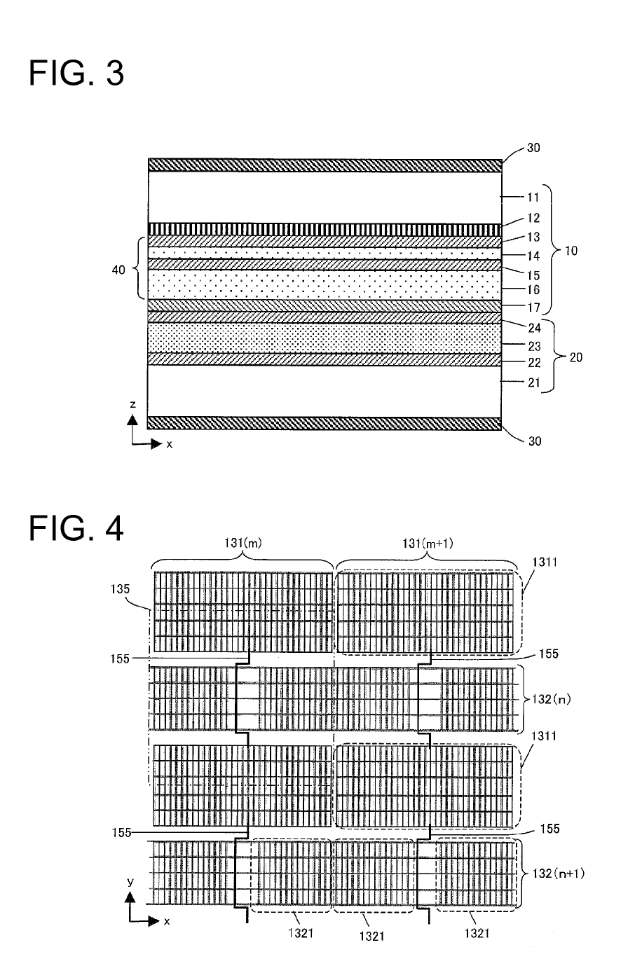

First, the fundamental configuration of the present invention will be explained using FIGS. 1 and 2, and then FIG. 3 onwards will be used to describe the embodiments of the present invention (Embodiment 1 to Embodiment 5) in detail. In the descriptions below, various limitations preferable for implementing the present invention are conferred, but the technical scope of the present invention is not limited by the disclosures of the embodiments and figures below. In the descriptions below, the same reference characters are given to identical members, and the description of these members will not be repeated. The figures are not drawn to scale, and the dimensions of part of a member may be expanded in the drawings for convenience of explanation.

(Fundamental Configuration of Present Invention)

FIGS. 1(a) and 1(b) are views of the fundamental configuration of the color filter-integrated touch panel according to the present invention. The color filter-integrated touch panel of the present invention is integrated with a liquid crystal display component to form a liquid crystal display device.

In FIG. 1(a), the reference character 10 is the color filter-integrated touch panel of the present invention, and reference character 20 is the liquid crystal display component that is combined with the color filter-integrated touch panel. The color filter-integrated touch panel 10 and the liquid crystal display component 20 constitute a liquid crystal display device having a touch panel attached thereto.

As shown in FIG. 1(a), the color filter-integrated touch panel 10 includes a color filter glass substrate 11, a first mesh layer 13, a first insulating layer 14, a second mesh layer 15, a second insulating layer, and a color filter 17. These are formed on the color filter glass substrate 11 in the above order.

Detection electrodes 131 and driving electrodes 132 are formed in the first mesh layer in a state insulated from each other, and floating electrodes 151 are formed in the second mesh layer 15. The floating electrodes 151 are insulated from the detection electrodes 131 and the driving electrodes 132 and, in practice, are not grounded, but are “floating.” The detection electrodes 131, the driving electrodes 132, and the floating electrodes 151 are all formed as a mesh-shaped electrode constituted of a plurality of meshes. It is preferable that these electrodes be constituted of a metal film with high conductivity, but a more detailed configuration will be described later using FIG. 3 onwards.

Ordinarily, when a voltage is applied to the driving electrodes in a capacitive touch panel, an electric flux occurs from the driving electrodes to the detection electrodes, and this electric flux increases and decreases depending on touch, thereby increasing and decreasing the capacitance between the driving electrodes and the detection electrodes and acting as a signal.

If shielding electrodes are disposed directly below the driving electrodes, a large portion of the electric flux generated by the driving electrodes is absorbed by the shielding electrodes, and the electric flux ceases to contribute to the signal. Floating electrodes, however, are disposed between the electrodes that serve as the absorption source of the electric flux, and thus alleviate the coupling with the common electrode that serves as the absorption source of the lines of electric force.

The detection electrodes 131, the driving electrodes 132, and the floating electrodes 151 insulated from the detection electrodes 131 and the driving electrodes 132 via the first insulating layer 14 form a capacitive touch panel component 40 for touch location detection. Namely, when a fingertip or the like touches a specific location on the color filter substrate 11 (the top in the drawing), the detection electrodes 131 detect a change in capacitance between the detection electrodes 131 and the driving electrodes 132, and a specific touch location is detected. These mechanisms are already known and will not be explained in detail. The color filter-integrated touch panel is constituted of the touch panel component 40 and the color filter 17. The viewer views the liquid crystal display device from the top of the color filter substrate 11 (the top in the drawing).

Reference character 20 is the liquid crystal display component, which has a glass substrate 21, a liquid crystal driving electrode 22 formed on this glass substrate 21, a liquid crystal common electrode 24 having a prescribed space (gap) being between the liquid crystal driving electrode 22 and this liquid crystal common electrode 24, and a liquid crystal layer 23 filled into the space between the liquid crystal driving electrode 22 and the liquid crystal common electrode 24. The liquid crystal common electrode 24 is formed on the color filter 17 on the color filter substrate 11 side. The color filter-integrated touch panel 10 and the liquid crystal display component 20 combine to form a touch panel-integrated liquid crystal display device.

In order to achieve multi-color display on the liquid crystal display component side, the color filter 17 ordinarily has color filters, each having one of the primary colors (RGB), with the color differing for each sub-pixel in every pixel. These configurations are already known, and thus will not be described in detail. A detailed configuration thereof is also not disclosed in FIG. 1. In summary, the color filter 17 is included in display devices such as liquid crystal display devices and makes it possible for the display device to perform multi-color display.

FIG. 1(b) shows the minimum parameters (positional relationship) that the floating electrodes 151, the detection electrodes 131, and the driving electrodes 132 should have. As described above, the detection electrodes 131 and the driving electrodes 132 are both formed in the first mesh layer 13 and are insulated from each other, and the floating electrodes 151 are formed between the detection electrodes 131, the driving electrodes 132 and the color filter 17 (see FIG. 1(a)). This makes it so that the floating electrodes 151 are formed between the detection electrodes 131, the driving electrodes 132 and the liquid crystal common electrode 24 of the liquid crystal display component 20 with which these detection electrodes 131 and driving electrodes 132 will be combined and used. As shown in FIG. 1(b), the floating electrodes 151 are arranged so as to straddle the driving electrodes 132 and the portions of the detection electrodes 131 adjacent to the edges of the respective driving electrodes 132. The reason for this configuration will be explained later with FIG. 2.

In summary of the above, the color filter-integrated touch panel according to the present invention includes: a substrate; a touch panel component having detection electrodes and driving electrodes for touch location detection disposed on the substrate; and a color filter formed on the touch panel component, the color filter making multicolor display possible after being combined with a display device, wherein the detection electrodes and the driving electrodes of the touch panel component are insulated from each other and are mesh-shaped electrodes formed from a plurality of meshes, wherein mesh-shaped floating electrodes formed from a plurality of meshes are disposed between the color filter and the touch panel component having the detection electrodes and the driving electrodes, the floating electrodes being electrically insulated from the detection electrodes and the driving electrodes, and wherein the floating electrodes abut at least the detection electrodes that are adjacent to an area around the driving electrodes, the driving electrodes being at a center thereof.

Next, the effects based on the color filter-integrated touch panel of the present invention will be explained using FIG. 2. FIG. 2(a) shows distribution of lines of electric force when a driving voltage is applied to the driving electrodes 132 in a liquid crystal display device having the color filter-integrated touch panel of the present invention. FIG. 2(b) also shows lines of electric force when a driving voltage is applied to driving electrodes 132 in a liquid crystal display device having a conventional color filter-integrated touch panel. As explained above, in the liquid crystal display device using the color filter-integrated touch panel of the present invention, the floating electrodes 151 are disposed between the detection electrodes 131, the driving electrodes 132 and the liquid crystal common electrode 24 of the liquid crystal display component 20.

In the color filter-integrated touch panel of the present invention, the detection electrodes 131, the driving electrodes 132, and the floating electrodes 151 are all formed as a mesh-shaped electrode constituted of a plurality of meshes. Therefore, it is possible to prevent increases in capacitor components based on the detection electrodes 131 and the driving electrodes 132 of the touch panel, and allows for the surface area of the touch panel to be made larger due to an increase in capacitance. However, a metal film having excellent conductivity is used as the material of the mesh-shaped electrode in accordance with the surface area of the touch panel, due to a large surface area touch panel causing an increase in resistance because of the enlargement of the driving electrodes and the mesh shape of the electrode.

In the liquid crystal display device having the conventional color filter-integrated touch panel, if a driving voltage is applied between the detection electrodes 131 and the driving electrodes 132, then as shown in FIG. 2(b), a portion of the lines of electric force from the driving electrodes 132 reaches the detection electrode 131 side, but most of the lines of electric force go through the meshes of the driving electrodes 132 and escape towards the liquid crystal common electrode 24. In liquid crystal display devices having the capacitive touch panel formed in integration therewith (in-cell capacitive touch panel), the driving electrodes 132 of the touch panel and the common electrode of the liquid crystal display device are arranged physically close to each other, which increases the coupling effect between the driving electrodes of the touch panel and the common electrode of the liquid crystal display device.

As shown in FIG. 2(a), in the liquid crystal display device having the color filter-integrated touch panel of the present invention, the floating electrodes 151 are disposed between the detection electrodes 131, the driving electrodes 132 and the liquid crystal common electrode 24. In this case, even if a driving voltage is applied between the driving electrodes 132 and the detection electrodes 131, the presence of the floating electrodes 151 weakens the coupling between the driving electrodes 132 and the liquid crystal common electrode 24, and relatively strengthens the coupling between the driving electrodes 132 and the detection electrodes 131. As a result, as shown in FIG. 2(a), it is possible to increase the amount of electric flux that rises to the touch location, and the signal strength for touch location detection can be improved.

This means that a touch location detection of a sufficient sensitivity can be obtained even if detection electrodes and driving electrodes having a mesh shape and reduced capacitor components are used; therefore, it is possible to realize a touch panel that allows for an increase in surface area. In particular, when a metal film having excellent conductivity is used for the detection electrodes, driving electrodes, floating electrodes, and the like, it is possible to suppress an increase in resistance of the electrodes and to obtain a touch panel having a larger surface area.

### Embodiment 1

FIGS. 3 to 8 show Embodiment 1 related to a color filter-integrated touch panel of the present invention. In FIGS. 3 to 8, members that are the same as in FIG. 1 are given the same reference characters, and a detailed description of these members will not be repeated.

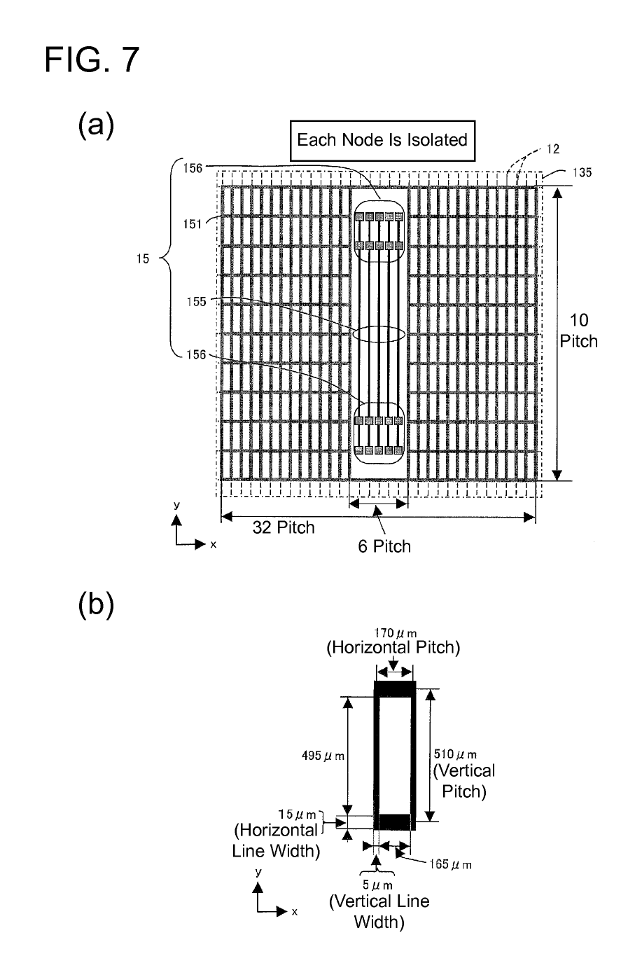

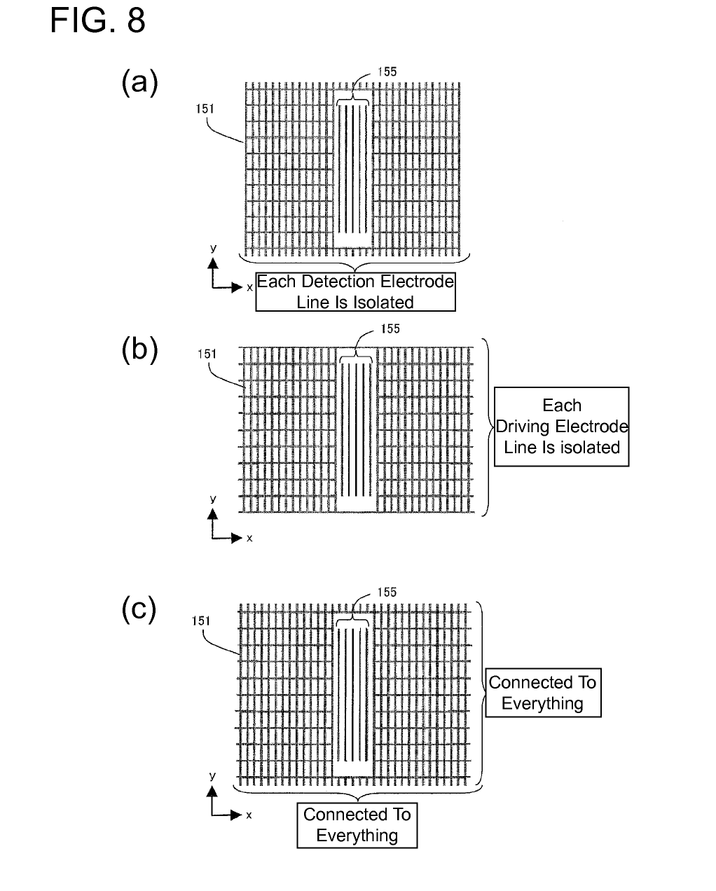

FIG. 3 is a view of the cross-sectional structure of the color filter-integrated touch panel of Embodiment 1 and shows a liquid crystal display device in which the color filter-integrated touch panel according to Embodiment 1 of the present invention has been integrated with a liquid crystal display component. FIGS. 4 to 6 show configurations of detection electrodes 131 and driving electrodes 132 formed in a first mesh layer 13, and FIGS. 7 and 8 show configurations of floating electrodes 151 formed in a second mesh layer 15. In FIGS. 3 to 8, the color filter-integrated touch panel of the present invention spreads (has a plane) in the X axis direction to Y axis direction, and has a thickness (cross-section) in the Z axis direction.

In FIG. 3, reference character 10 is the color filter-integrated touch panel, which includes a touch panel component 40 and a color filter 17. The touch panel component 40 is a so-called in-cell capacitive touch panel, and has a first mesh layer 13, a first insulating layer 14, a second mesh layer 15, and a second insulating layer 16. Detection electrodes 131 and driving electrodes 132, which will be explained using FIGS. 4 to 6, are formed in the first mesh layer 13. Floating electrodes 151, which will be explained using FIGS. 7 and 8, are formed in the second mesh layer 15. In the color filter-integrated touch panel of Embodiment 1 shown in FIG. 3, a black matrix (or light shielding section) 12 is formed on a color filter substrate 11. In other words, a touch panel component is formed in which the detection electrodes 131 and the driving electrodes 132 are under the black matrix (or light shielding section) 12 when seen from the viewing side of the display device.

In Embodiment 1, the detection electrodes 131 and the driving electrodes 132 are all constituted of a 0.2 μm metal film formed in the first mesh layer 13. The floating electrodes 151 and the detection electrode metal bridges 155 are constituted of a 0.2 μm metal film formed in the second mesh layer 15. A Ti film, a three-layer film of Ti/Al/Ti, a two-layer film of Mo/Al, or the like can be used as the metal film, for example. The thickness of the first insulating layer 14 is 2 μm and the thickness of the second insulating layer 16 is 4 μm. The reason the second insulating layer 16 is made thicker than the first insulating layer is to separate a liquid crystal common electrode 24 from the other electrodes (the floating electrodes 151, the detection electrodes 131, and the driving electrodes 132) and to weaken the coupling with the consultation electrode 24 as much as possible.

Reference character 20 is the liquid crystal display component, which will be combined with the color filter-integrated touch panel 10 and used. The liquid crystal display component 20 includes a glass substrate 21, a liquid crystal driving electrode 22, the liquid crystal common electrode 24, and a liquid crystal layer 23 filled into the area (space) between the liquid crystal driving electrode and the liquid crystal common electrode. 30 and 30 are polarizing plates. The liquid crystal display device having the touch panel formed in integration therewith is constituted of the color filter-integrated touch panel 10 that includes the color filter 17, the liquid crystal display component 20, and the two polarizing plates 30 and 30.

In Embodiment 1 shown in FIG. 3, the liquid crystal display component 20 is shown, but a plasma display component (a plasma display device without the color filter), a white light-emitting EL display component (an EL display device without the color filter in which it is possible to perform color display by disposing a color filter on the white light-emitting EL panel), or the like can be used instead.

Providing the color filter 17 and the black matrix 12 are techniques that are already known and a detailed explanation thereof will be omitted. In Embodiment 1, however, the color filter 17 has color filters, each being of one of three primary colors (RGB), in each sub-pixel of every pixel in the liquid crystal display device 20. The black matrix (or light shielding section) 12 is ordinarily formed so as to correspond to the edges of the respective sub-pixels. However, the black matrix is not limited to this, and generally speaking, the black matrix (or light shielding section) 12 is a member that is formed on the color filter in a location adjacent to the viewer and functions as a light shielding section that shields unnecessary light and the like from the display device. In addition to a display device using the three primary colors, RGB, a display device that uses four colors, such as RGBW, which has W (white) or the like added can be used, but a detailed explanation thereof will be omitted.

FIG. 4 shows details of the first mesh layer 13. A plurality of detection electrodes 131(m) and 131(m+1) that extend in the Y axis direction and a plurality of driving electrodes 132(n) and 132(n+1) that extend in the X axis direction are formed in the first mesh layer 13. Needless to say, the plurality of detection electrodes 131(m) and 131(m+1) are insulated from each other, and in a similar manner, the plurality of driving electrodes 132(n) and 132(n+1) are insulated from each other. In the explanation below, unless referring to a specific detection electrode, the plurality of detection electrodes 131(m), 131(m+1), and so on are simply described as the “detection electrodes 131” and, in a similar manner, unless referring to a specific driving electrode, the plurality of driving electrodes 132(n), 132(n+1) and so on are simply described as the “driving electrodes 132.”

In Embodiment 1 shown in FIG. 4, the driving electrodes 132 are electrically connected in the X axis direction in the first mesh layer 13, and the detection electrodes 131 are electrically connected in the Y axis direction by detection electrode metal bridges 155 disposed in the second mesh layer 15, which is explained later. The detection electrodes 131 and the driving electrodes 132 are all mesh-shaped electrodes constituted of a plurality of meshes, and the plurality of meshes are formed corresponding to the respective edges of the sub-pixels in the liquid crystal display component 20, which will be used after being combined. Accordingly, this results in the meshes being formed corresponding to the respective edges of the sub-pixels in the liquid crystal display component 20, in a manner similar to the black matrix 12.

In FIG. 4, the reference character 135 is the area assumed to be the smallest unit for touch location detection of the touch panel, and in the present invention this area is referred to as “one node area.”

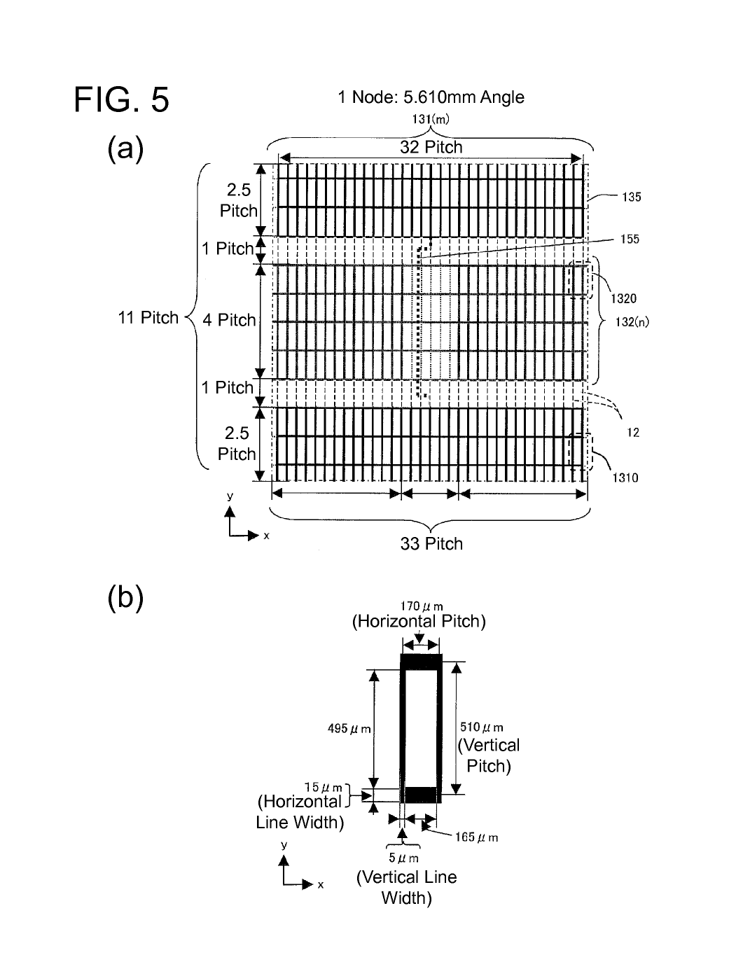

FIG. 5(a) shows a more detailed configuration of the detection electrodes 131 and the driving electrodes 132 of Embodiment 1, in which the range of the one node area 135 has been magnified. In FIG. 5(a), the length of one mesh (length of one unit) forming a portion of the electrodes is described as “one pitch.” Although not shown in FIG. 4, in FIG. 5(a) the reference character 12 is the black matrix, and as shown in FIG. 5(a), the black matrix is formed in a mesh shape having a plurality of meshes. As already explained, this black matrix 12 is ordinarily formed corresponding to the respective edges of the sub-pixels in the display device, which will be used after being combined.

As shown in FIG. 5(a), the detection electrodes 131 and the driving electrodes 132 in the one node area 135 are formed in the X axis direction at a pitch of 33, and in the Y axis direction at a pitch of 11, respectively. The pitch in the X axis direction and the Y axis direction are different from each other, but in Embodiment 1, as shown in FIG. 5(b), the dimensions in the X axis direction and Y axis direction of a single mesh are made to be different, and the one node area 135 in its entirety is designed to be a 5.610 mm quadrilateral shape.

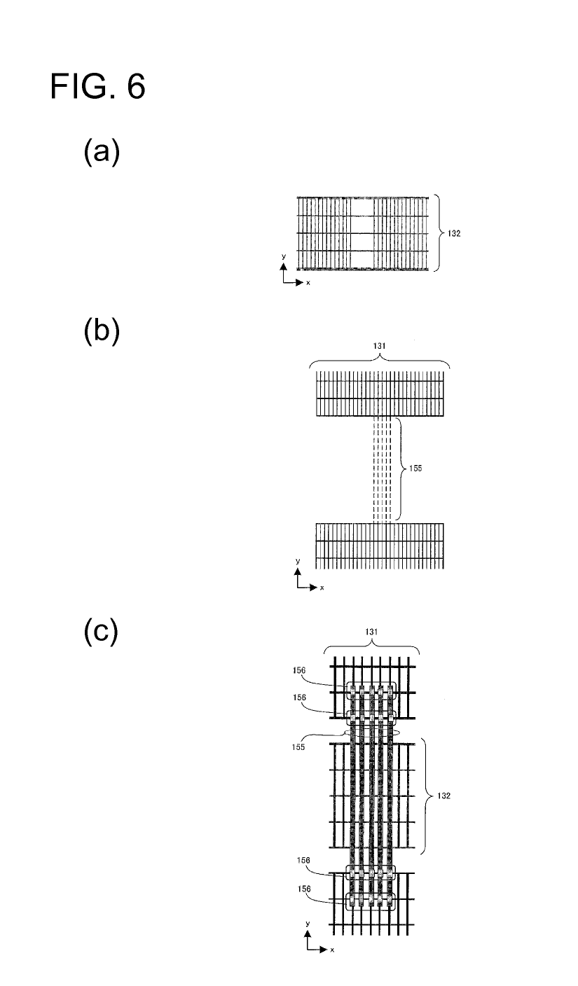

The detection electrodes 131 in the one node area 135 are constituted of two areas divided along both edges in the Y axis direction, with one area being formed at a pitch of 32 along the X axis direction and the other area being formed at a pitch of 2.5 along the Y axis direction. The first detection electrodes 131 are electrically connected to each other by detection electrode metal bridges 155 formed in the second mesh layer 15. The configuration of the detection electrode metal bridges 155 will be described in detail using FIG. 6(c).

The driving electrodes 132 have a width of 4 pitches along the Y axis direction and are formed across the center of the detection electrodes 131 in the Y axis direction. The driving electrodes 132 have “portions omitting a portion of the mesh” formed at 6 pitch intervals along the X axis direction at the center in the X axis direction. Two areas of the driving electrodes 132 are formed at pitches of 13.5, respectively, along the X axis direction, and are electrically connected in the X axis direction.

As shown in FIGS. 4 and 5, in Embodiment 1 the detection electrodes 131 are constituted of a plurality of rectangular electrodes 1311 (see FIG. 4), which are themselves constituted of a plurality of meshes 1310 (see FIG. 5) extending in the X axis direction and the Y axis direction. The rectangular electrodes 1311 are electrically connected in the Y axis direction. The driving electrodes 132 are constituted of a plurality of rectangular electrodes 1321 (see FIG. 4), which are themselves constituted of a plurality of meshes 1320 (see FIG. 5) extending in the X axis direction and the Y axis direction. The rectangular electrodes 1321 are electrically connected in the X axis direction.

In FIG. 5(b), a specific design example is shown in which one mesh 1310 constituting one detection electrode 131 and one mesh 1320 constituting one driving electrode 132 are shown. The meshes 1310 and the meshes 1320 are designed with the same size. As shown in FIG. 5(b), a single mesh electrode has a vertical line width (line width in the Y axis direction) of 5 μm, a horizontal line width (line width in the X axis direction) of 15 μm, a vertical pitch (in the Y axis direction) of 510 μm, and internal dimensions of 165μ×495 μm. These values correspond to one design example, and the present invention is not limited to these values, but as described later, it is confirmed that a touch panel with a large surface area can be formed if these values are followed.

FIG. 6 shows the detection electrodes 131 and the driving electrodes 132 formed in the one node area 135 in a way that is easier to understand. FIG. 6(a) shows only the driving electrodes 132, and FIG. 6(b) shows only the detection electrodes 131. The detection electrodes 131 are connected to each other by the detection electrode metal bridges 155 disposed in the second mesh layer 15.

FIG. 6(c) shows details of the detection electrode metal bridges 155. The detection electrode metal bridges 155 are formed in the second mesh layer 15, which is insulated from the detection electrodes 131 by the first insulating layer 14, but the detection electrode metal bridges are electrically connected to the detection electrodes 131 formed in the first mesh layer 13 by contact holes 156 as shown in FIG. 6(c).

In Embodiment 1, five of the detection electrode metal bridges 155 are provided, and a contact hole is formed both above and below in each of the metal bridges to ensure a reliable electrical connection. In FIG. 6(c), the line width of the detection electrode metal bridges is shown as thicker (wider) than the line width of the detection electrodes 131 and the driving electrodes 132, but this is for convenience of explanation, and in practice the metal bridges may be the same width as the detection electrodes 131 and the driving electrodes 132. It is preferable that a metal film be used for the detection electrode metal bridges, due to conductivity, but it is also possible to use a transparent conductive film such as ITO, depending on the size of the touch panel. It is also possible to use a carbon-based conductive material (carbon nanotubes, graphene, or the like).

FIG. 7 shows the floating electrodes 151 and the detection electrode metal bridges 156 formed in the second mesh layer 15 of the color filter-integrated touch panel 10 in more detail. FIG. 7(a) shows the floating electrodes 151 and the detection electrode metal bridges 155 formed in the one node area 135 and FIG. 7(b) shows a specific design example of one mesh of the floating electrodes 135.

As shown in FIG. 7(a), the floating electrodes 151 of Embodiment 1 have a width at a pitch of 32 in the X axis direction (horizontal direction in the drawing) and a width at a pitch of 10 in the Y axis direction (vertical direction in the drawing). The floating electrodes 151 are isolated in this one node area 135. In other words, the floating electrodes 151 are electrically insulated in the one node area 135. In the center of the floating electrodes 151, a 6-pitch portion of the floating electrodes 151 has been removed, and the detection electrode metal bridges 155 are disposed at this location.

The floating electrodes 151 and the detection electrode metal bridges can be formed with the same metal film, and in such a case the detection electrode metal bridges, which are required to have high conductivity, and the floating electrodes can be formed by one round of metal film deposition and then patterning through photolithography. This makes the manufacturing process easier. The floating electrodes 151 are divided into left and right in the drawing by the center portion, but the floating electrodes 151 are electrically connected to each other at both ends thereof in the Y axis direction. The reference character 156 shows the contact holes.

In the structure of the floating electrode 151 shown in FIG. 7(a), the floating electrodes 151 are electrically insulated in each one node area 135, but even with this type of configuration, coupling between the driving electrodes 132 and the liquid crystal common electrode 24 (see FIG. 2(b) and FIG. 3) on the liquid crystal display component 20 side can be suppressed, and degradation of the detection signals when the touch panel is used can also be suppressed. This means that even if the detection electrodes and the driving electrodes that are mesh-shaped and have a reduction of capacitor components are used, touch location detection that is sufficiently sensitive can be performed, and thus, this makes it possible to realize a touch panel that can have a larger surface area.

As described above, FIG. 7(b) shows a specific design example of one mesh of the floating electrodes 135. As can be seen when comparing FIGS. 7(b) and 5(b), the single mesh forming one of the floating electrodes 151 has the same design as the single mesh forming one of the detection electrodes 131 and the driving electrodes 132. These meshes are all formed corresponding to the respective edges of the black matrix 12, or namely, the respective edges of the sub-pixels in the display device, which will be used after being combined.

As described above, in the color filter-integrated touch panel in Embodiment 1, the meshes of the detection electrodes 131, the driving electrodes 132, and the floating electrodes 151 are formed corresponding to the respective edges of sub-pixels in each pixel of the display device, which will be used after being combined. There meshes are formed in areas that do not traditionally affect the display quality of the display device. Accordingly, even if these detection electrodes 131, driving electrodes 132, and floating electrodes 151 are made of a metal film with good conductivity, adverse effects on the display quality of the display device can be suppressed. A Ti film, a three-layer film of Ti/Al/Ti, a two-layer film of Mo/Al, or the like can be used as the metal film, for example.

In Embodiment 1 described above, the meshes of the detection electrodes 131, the driving electrodes 132, and the floating electrodes 151 were formed corresponding to the respective edges of the sub-pixels in each pixel of the display device, which will be used after being combined, but the present invention is not limited to this. The meshes of the detection electrodes 131 and driving electrodes 132 and the meshes of the floating electrodes 151 may all be formed corresponding in a plan view to the location where the black matrix (shielding section) 12 is formed on the color filters and adjacent to the viewer, for example. “Corresponding in a plan view” means that the meshes of the detection electrodes 131, the driving electrodes 132, and the floating electrodes 151 overlap the black matrix (light shielding section) 12 when seen from the viewer's side, and thus are formed in a positional relationship that does not deviate in a plan view.

In conventional touch panels that use a transparent electrode such as ITO instead of detection electrodes, driving electrodes, and floating electrodes, the limit for the touch panel is approximately 11 inches, but with the configuration of the present invention, this size can be substantially increased. It is predicted that the size of the touch panel can be increased to approximately 42 inches by lowering resistance and capacitance with detection electrodes and driving electrodes being meshes made of a metal film and suppressing signal degradation by providing floating electrodes made of the metal film, as shown in Embodiment 1 of the present invention, for example. Large currents do not ordinarily flow to the floating electrodes, and thus it is possible to have a touch panel with a larger screen than conventional configurations even if the floating electrodes are transparent electrodes instead of the metal film, for example.

In the color filter-integrated touch panel of Embodiment 1 shown in FIG. 3, the black matrix 12 is provided at a location closer to the viewer than the touch panel component 40. Therefore, in the color filter-integrated touch panel of Embodiment 1, the presence of the detection electrodes 131 and the driving electrodes 132 will not be noticed by the viewer even if the detection electrodes 131 and the driving electrodes 132 are made of a metal film, and display quality will also not be reduced by this configuration.

In the examples shown in FIGS. 4 to 8, it is stated that “the meshes of the detection electrodes 131, the driving electrodes 132, and the floating electrodes 151 are formed corresponding to the respective edges of the sub-pixels in the display device, which will be used after being combined,” but the present invention is not necessarily limited to this. For an ultra-high definition display device in which the sub-pixel size is made as small as possible, the meshes of the detection electrodes 131, the driving electrodes 132, and the floating electrodes 151 may be formed corresponding to the respective edges of the pixels, for example. All of the meshes of the detection electrodes 131, the driving electrodes 132, and the floating electrodes 151 may be different sizes, such as making the meshes 151 of the floating electrodes 151 larger or smaller, for example.

FIG. 8 shows three modification examples of the floating electrodes 151. The floating electrodes 151 shown in FIG. 8(a) are formed isolated from each line of the detection electrodes 131. In other words, the floating electrodes 151 are electrically connected in the Y axis direction (vertical direction in the drawing) in which the detection electrodes 131 are connected, but insulated from the detection electrodes 131 in the width direction in the X axis direction (horizontal direction in the drawing).

Even with the floating electrodes 151 having this kind of configuration, it is possible to avoid coupling of the driving electrodes 132 and the liquid crystal common electrode 24 (see FIG. 2(b) and FIG. 3) of the liquid crystal display component 20, and also possible to avoid degradation of detection signals when used as a touch panel. This means that even if the detection electrodes and the driving electrodes that are mesh-shaped and have a reduction of capacitor components are used, touch location detection that is sufficiently sensitive can be performed, and thus, this makes it possible to realize a touch panel that can have a larger surface area.

In FIG. 8(b), another modification example of the floating electrodes 151 is shown. In the modification example shown in FIG. 8(b), the floating electrodes 151 are formed connected for each driving electrode line. In other words, the floating electrodes 151 are electrically connected in the X axis direction (horizontal direction in the drawing), which is the direction in which the driving electrodes 132 are connected, and insulated in the width direction of the driving electrodes 132 in the Y axis direction (vertical direction in the drawing).

Even with the floating electrodes 151 having this kind of configuration, it is possible to avoid coupling of the driving electrodes 132 and the liquid crystal common electrode 24 (see FIG. 2(b) and FIG. 3) of the liquid crystal display component 20, and also possible to avoid degradation of detection signals when used as a touch panel. This means that even if the detection electrodes and the driving electrodes that are mesh-shaped and have a reduction of capacitor components are used, touch location detection that is sufficiently sensitive can be performed, and thus, this makes it possible to realize a touch panel that can have a larger surface area.

In FIG. 8(c), another modification example of the floating electrodes 151 is shown. In the modification example shown in FIG. 8(c), the floating electrodes 151 are connected to the entire surface of the touch panel component 40. In other words, the floating electrodes 151 are electrically connected in the X axis direction (vertical direction in the drawing), which is the direction in which the detection electrodes 131 are connected, and also connected in the X axis direction (horizontal direction in the drawings), which is the direction in which the driving electrodes 132 are connected.

Even with the floating electrodes 151 having this kind of configuration, it is possible to avoid coupling of the driving electrodes 132 and the liquid crystal common electrode 24 (see FIG. 2(b) and FIG. 3) of the liquid crystal display component 20, and also possible to avoid degradation of detection signals when used as a touch panel. This means that even if the detection electrodes and the driving electrodes that are mesh-shaped and have a reduction of capacitor components are used, touch location detection that is sufficiently sensitive can be performed, and thus, this makes it possible to realize a touch panel that can have a larger surface area.

As explained above, the floating electrodes 151 all cover a large portion of the detection electrodes 131 in the one node area 135, but the floating electrodes 151 do not necessarily have to be formed in this manner. Namely, as shown in FIG. 1(b), the floating electrodes 151 may be formed so as to contact the portion of the detection electrodes 131 that is adjacent to at least the area surrounding the driving electrodes 132 with the driving electrodes 132 at the center thereof.

Conversely, when the floating electrodes 151 are formed on almost the entire surface of the detection electrodes 131 in the one node area 135, if the floating electrodes 151 are combined with the detection electrode metal bridges 155, then the mesh metal film will be formed on almost the entire surface of the touch panel component 40. In this case, it is possible for the mesh electrodes formed in the second mesh layer 15 to have a black matrix function. Namely, when using a configuration in which detection electrode metal bridges for connecting the floating electrodes to the detection electrodes are formed in the second mesh layer 15 and these floating electrodes 151 and detection electrode metal bridges 155 are formed separated from each other at a distance of a single mesh or smaller, then it is possible to have a sufficient black matrix function with respect to the sub-pixels in the liquid crystal display component.

(Method of Manufacturing Color Filter-Integrated Touch Panel)

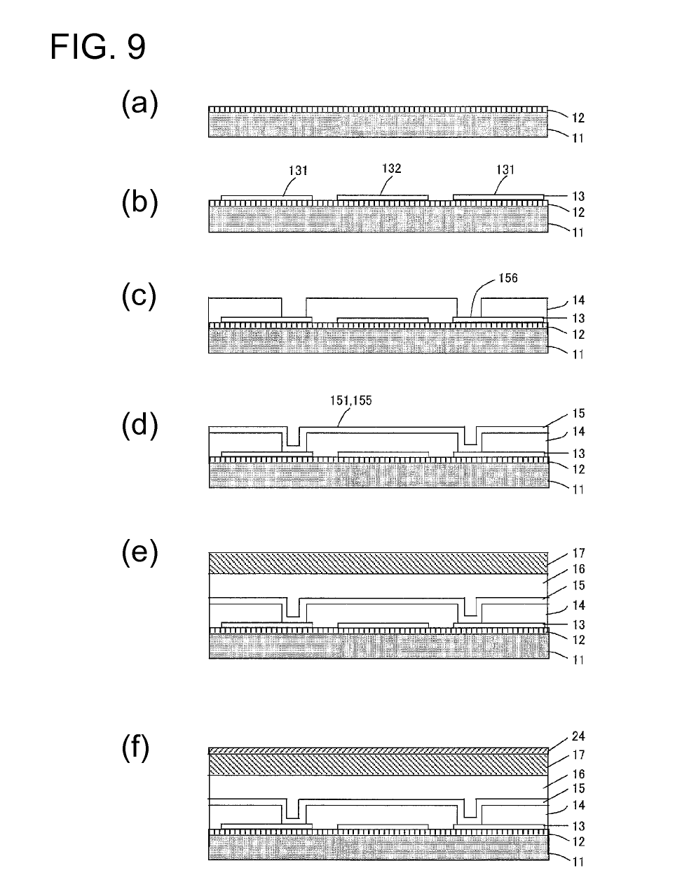

Next, a method of manufacturing the color filter-integrated touch panel according to Embodiment 1 of the present invention as shown in FIGS. 1 to 8 will be described with reference to FIG. 9. There are no specific descriptions for methods of manufacturing the respective color filter-integrated touch panels described in Embodiments 2 to 5, but one with ordinary skill in the art can conceive of such methods with ease from FIG. 9.

FIGS. 9(a) to 9(f) show respective steps of the method of manufacturing the color filter-integrated touch panel according to Embodiment 1.

First, the color filter glass substrate 11 (hereinafter, described as simply the “substrate” 11) is prepared, and the black matrix is formed on this glass substrate. Namely, the resin for forming the black matrix is formed on one surface of the glass substrate, and then photolithography is used to remove unnecessary portions, thereby forming the mesh-like black matrix 12. (See FIG. 9(a))

Next, the metal film for forming the detection electrodes and driving electrodes is formed on the substrate 11 on which the black matrix 12 is formed, and then the mesh-like detection electrodes 131 and driving electrodes 132 are formed by photolithography. (See FIG. 9(b))

Next, an insulating film that will become the first insulating layer 14 is formed on the substrate 11 where the detection electrodes 131 and the driving electrodes 132 are formed, and contact holes 156 for connecting the detection electrode metal bridges to the detection electrodes 131 is formed by photolithography. (See FIG. 9(c))

Next, the metal film for forming the floating electrodes and the detection electrode metal bridges is formed, and the floating electrodes 151 and detection electrodes metal bridges 155 are formed by photolithography. Although not specifically described, at this time, the detection electrodes are connected to each other in the Y axis direction by the detection electrode metal bridges through the respective contact holes 156. (See FIG. 9(d))

Next, the insulating film that will become the second insulating film 16 is formed, and the color filter 17 is formed on top of this. Although the details are omitted, the color filter 17 is a made of a layer that has a R, G, or B portion formed in each sub-pixel, for example. (See FIG. 9(e))

Finally, the liquid crystal common electrode 24 for the liquid crystal display device, which will be used after being combined, is formed. (See FIG. 9(f))

A metal film such as Ti, a three-layer film of Ti/Al/Ti, a two-layer film of Mo/Al, or the like can be used for the detection electrodes and the driving electrodes. The insulating layer can be a JAS interlayer insulating film (permittivity of approximately 3.9) used in general liquid crystal processes, but is more preferably a material with lower permittivity.

To assemble a liquid crystal display device using the “color filter-integrated touch panel” manufactured by the method shown in FIG. 9, this “color filter-integrated touch panel” is adhered to a “another substrate on which liquid crystal driving electrodes and the like are formed” with a gap therebetween for forming the liquid crystal layer.

(Simulation Results)

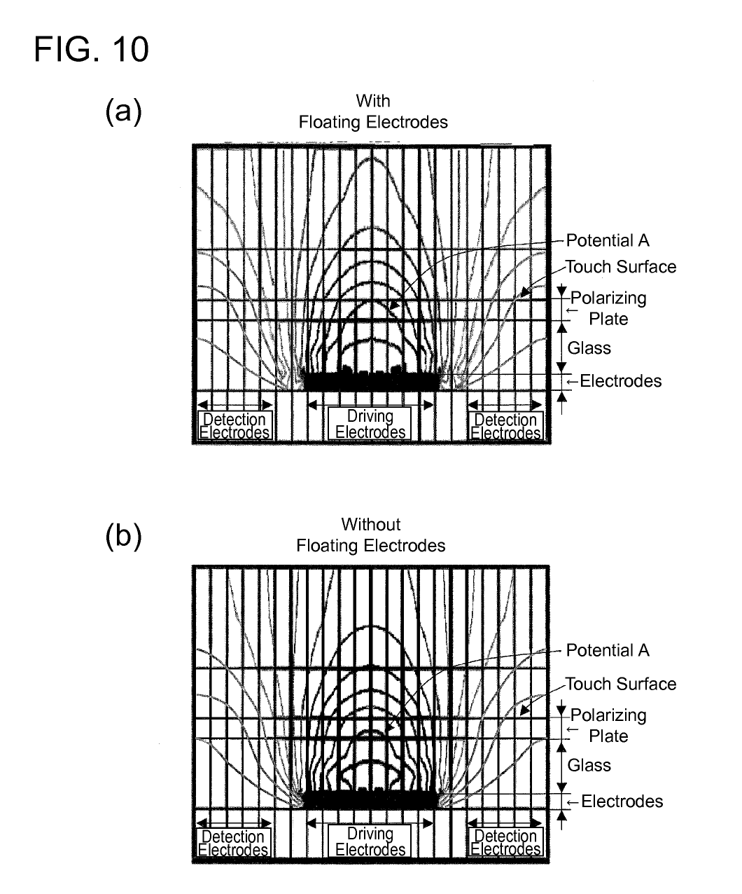

FIG. 10 shows simulation results of the color filter-integrated touch panel of Embodiment 1 according to the present invention.

FIG. 10(a) is a configuration provided with the floating electrodes according to the present invention, and FIG. 10(b) is a configuration not provided with the floating electrodes. FIG. 10 shows a state in which the potential given to the driving electrodes reaches the top of the polarizing plate disposed on top of the glass substrate. In the “With Floating Electrodes” configuration (see FIG. 10(a)), the specific potential A reaches the touch surface, but in the “Without Floating Electrodes (see FIG. 10(b)), the potential clearly not does not reach the touch surface. In other words, the potential of the touch surface is higher in the With Floating Electrodes configuration than the Without Floating Electrodes configuration. Although merely a qualitative value, the highest voltage of the touch surface without the floating electrodes is 57, compared to 60 for the configuration with the floating electrodes. It can be seen that the difference in voltage of the configuration with the floating electrodes with respect to the potential 0 (zero) of the detection electrodes becomes larger and that the signals then become larger.

In a capacitive touch panel, the presence or absence of capacitance generated by the difference in potential between the touch surface and the detection electrodes serves as a signal, and thus, the larger the difference is between the touch surface and the detection electrodes (potential: 0), the bigger the touch detection output will become. Accordingly, it is understood that the signal strength obtained by the configuration according to the present invention is superior.

In a conventional touch panel, ΔCf=5.19, whereas in the simulation results, the color filter-integrated touch panel according to Embodiment 1 of the present invention is ΔCf=6.52.

### Embodiment 2

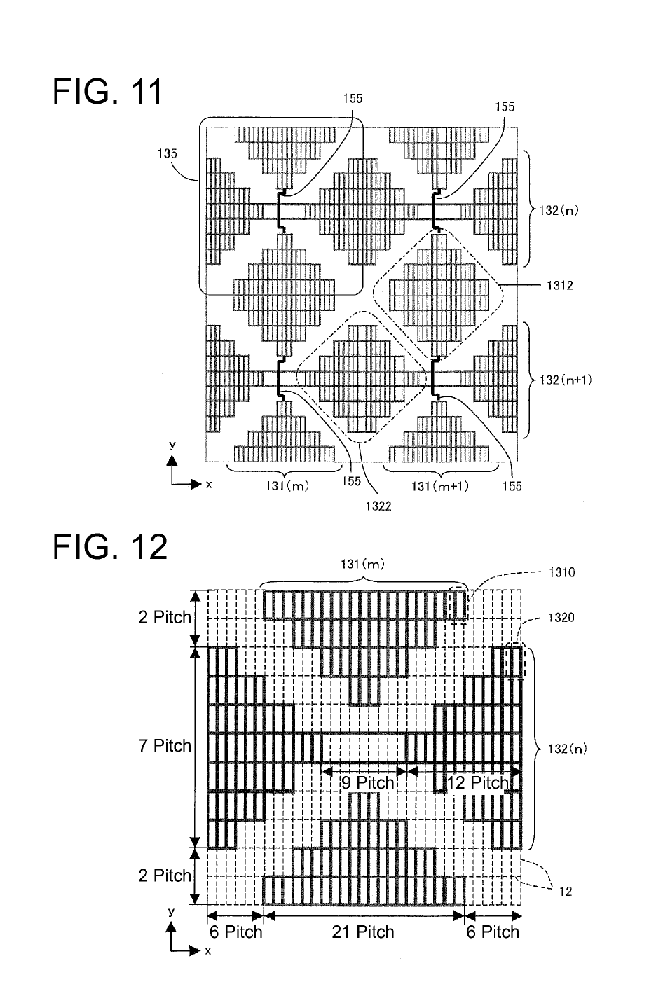

FIGS. 11 to 16 shows Embodiment 2 related to a color filter-integrated touch panel of the present invention. In FIGS. 11 to 16, members that are the same as in FIGS. 1 to 8 are given the same reference characters, and detailed explanations thereof will not be repeated. Embodiment 2 differs from Embodiment 1 in the shape of the detection electrodes and driving electrodes, but the material and the like for these may be the same. Furthermore, the cross-sectional structure of the color filter-integrated touch panel of Embodiment 2 is the same as the cross-sectional configuration of Embodiment 1 shown in FIG. 3, and a description of the cross-sectional view will be omitted.

FIGS. 11 and 12 show detection electrodes 131 and driving electrodes 132 according to Embodiment 2 of the present invention.

In FIG. 11, detection electrodes 131(m) and 131(m+1) extending in the Y axis direction and driving electrodes 132(n) and 132(n+1) extending in the X axis direction are shown, but in actual touch panels, a very large number of detection electrodes and driving electrodes are used depending on the size of the display device, which will be used after being combined. In the descriptions below, unless otherwise specified, these detection electrodes will simply be referred to as the “detection electrodes 131” and, in a similar manner, the driving electrodes will simply be referred to as the “driving electrodes 132.”

FIG. 12 shows a magnification of one node area 135 portion of the driving electrodes 131 and the driving electrodes 132. In a manner similar to Embodiment 1, the detection electrodes 131 and the driving electrodes 132 are electrically insulated from each other. These detection electrodes 131 and driving electrodes 132 are formed in a second mesh layer 13 (see FIG. 3), but detection electrode metal bridges 155 (see FIG. 11; not shown in FIG. 12) are formed in a second mesh layer 15 (see FIG. 3), and the detection electrode metal bridges 155 are connected to the detection electrodes 131 through the contact holes.

In Embodiment 2 shown in FIGS. 11 and 12, the detection electrodes 131 are constituted of a plurality of diamond-shaped electrodes 1312 (see FIG. 11), which are themselves constituted by a plurality of meshes 1310 (see FIG. 12) extending in the X axis direction and the Y axis direction. The detection electrodes are electrically connected in the Y axis direction. The driving electrodes 132 are constituted of a plurality of diamond-shaped electrodes 1322 (see FIG. 11), which are themselves constituted of a plurality of meshes 1320 (see FIG. 12) extending in the X axis direction and the Y axis direction. The driving electrodes 132 are connected in the X axis direction.

In FIG. 12, the reference character 12 shows a black matrix, and in Embodiment 2, in a manner similar to Embodiment 1, the black matrix 12, the meshes 1310 of the detection electrodes 131, and the meshes 1320 of the driving electrodes 132 are formed corresponding to respective edges of sub-pixels in each pixel of the display device, which will be used after being combined.

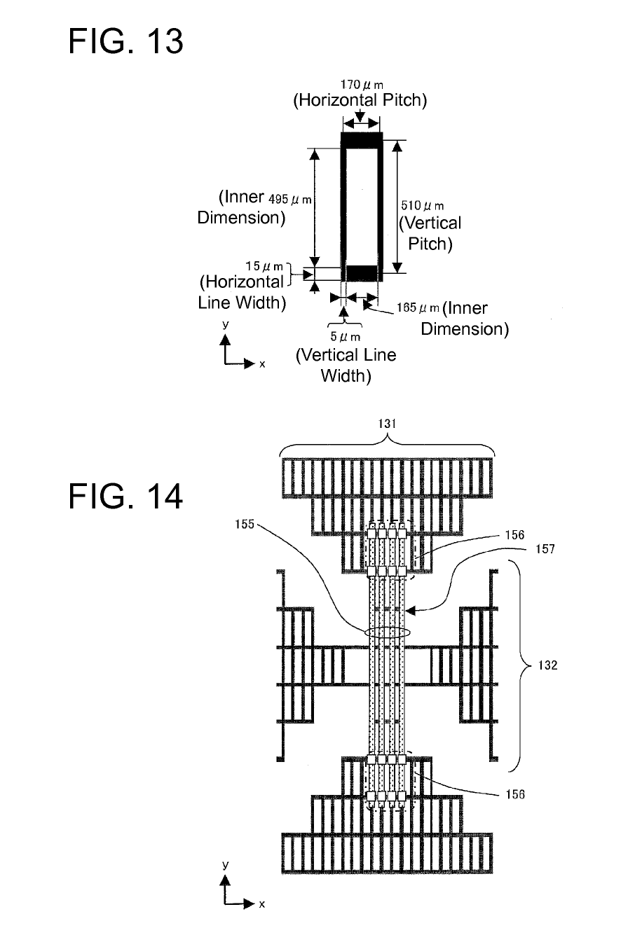

As shown in FIG. 12, the one node area 135 in Embodiment 2 is set at a pitch of 33 in the X axis direction and a pitch of 11 in the Y axis direction, but the size of this node area 135 in the present invention is not limited to this. The characteristics of the touch panel will change depending on the design values of the various members, and it is not necessarily easy to predict the effects of this in advance, but in Embodiment 3 a specific design example is shown of a single mesh of the detection electrodes 131 and the driving electrodes 132 in FIG. 13, which achieves very satisfactory results. As already explained, these meshes are formed corresponding to the respective edges of the sub-pixels in the display device, which will be used after being combined, but the design values shown in FIG. 13 are the same as the design values of the meshes shown in FIG. 5(b) and FIG. 7(b), and a detailed explanation thereof will be omitted.

FIG. 14 is a configuration example of the detection electrode metal bridges 155 in Embodiment 2. In Embodiment 2, four of the detection electrode metal bridges 155 are disposed on locations corresponding to the top portion of the diamond-shaped electrodes forming the detection electrodes 131. Contact holes 156 are formed above and below the detection electrode metal bridges and ensure a reliable electrical connection. The contact holes 156 are not provided in the outermost tip 157 of the detection electrodes 131, but this it to achieve a more reliable electrical connection by providing the contact holes 156 in a portion where the meshes of the driving electrodes 131 intersect. As already described, it is preferable that a metal film be used as the detection electrode metal bridges from the viewpoint of conductivity. Depending on the size of the touch panel, it is also possible to use a transparent conductive film such as ITO, or the like.

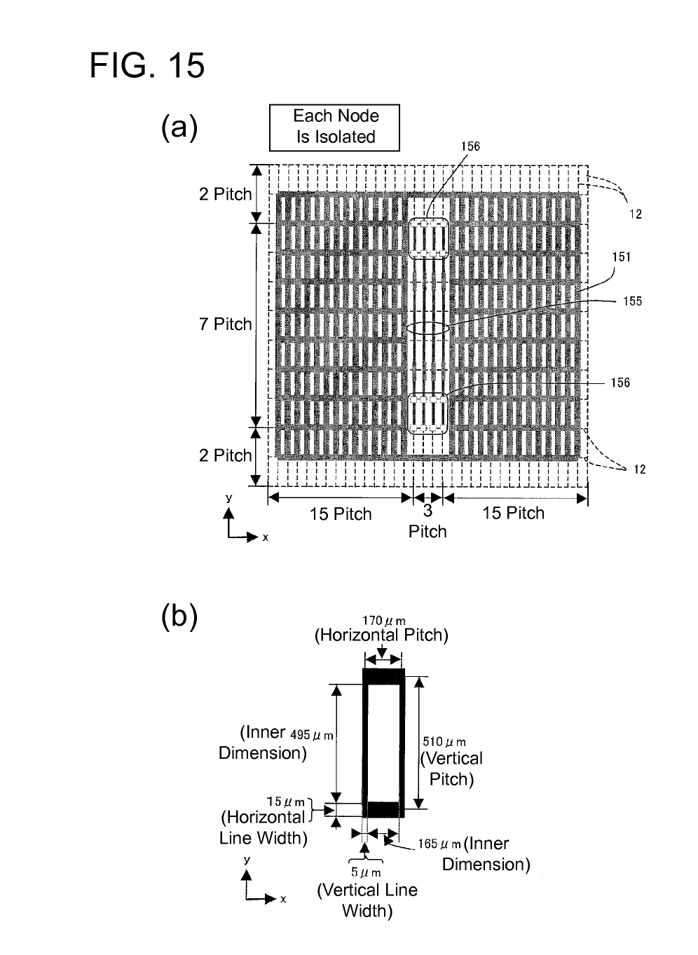

FIG. 15 shows the configuration of the floating electrodes 151 and the detection electrode metal bridges 155 in Embodiment 2. In Embodiment 2, the floating electrodes 151 are formed in the second mesh layer 15 of a color filter-integrated touch panel 10, in a manner similar to Embodiment 1.

FIG. 15(a) shows portions of the one node area 135 (see FIG. 11) that correspond to the detection electrodes 131 and the driving electrodes 132. As described above, FIG. 15(a) shows the floating electrodes 151, the detection electrode metal bridges 155, and at the same time, the “black matrix 12 formed corresponding to the respective edges of the sub-pixels in the display device, which will be used after being combined.”

As shown in FIG. 15(a), the floating electrodes 151 are formed isolated from each other in the one node area 135. The floating electrodes have a pitch of 9 in the Y axis direction and a pitch of 31 in the X axis direction. The detection electrode metal bridges 155 are formed in the X axis direction in the center, and this center portion has a blank area with a pitch of 4, except for both ends in the Y axis direction.

In the structure of the floating electrodes 151 in FIG. 15(a), the floating electrodes 151 are isolated from each other for each of the one node areas 135 and electrically insulated from each other, but even with this configuration, it is possible to suppress coupling of the driving electrodes 132 and the liquid crystal common electrode 24 on the liquid crystal display component 20 side (see FIG. 2(b) and FIG. 3); thus, detection signal degradation can be suppressed when this configuration is used in a touch panel. This means that even if the detection electrodes and the driving electrodes that are mesh-shaped and have a reduction of capacitor components are used, touch location detection that is sufficiently sensitive can be performed, and thus, this makes it possible to realize a touch panel that can have a larger surface area.

FIG. 15(b) shows a design example of one mesh of the floating electrodes 151. This design example is the same as the specific design example of the mesh of the detection electrodes 131 and the driving electrodes 132 shown in FIG. 13, and a detailed explanation thereof will not be repeated.

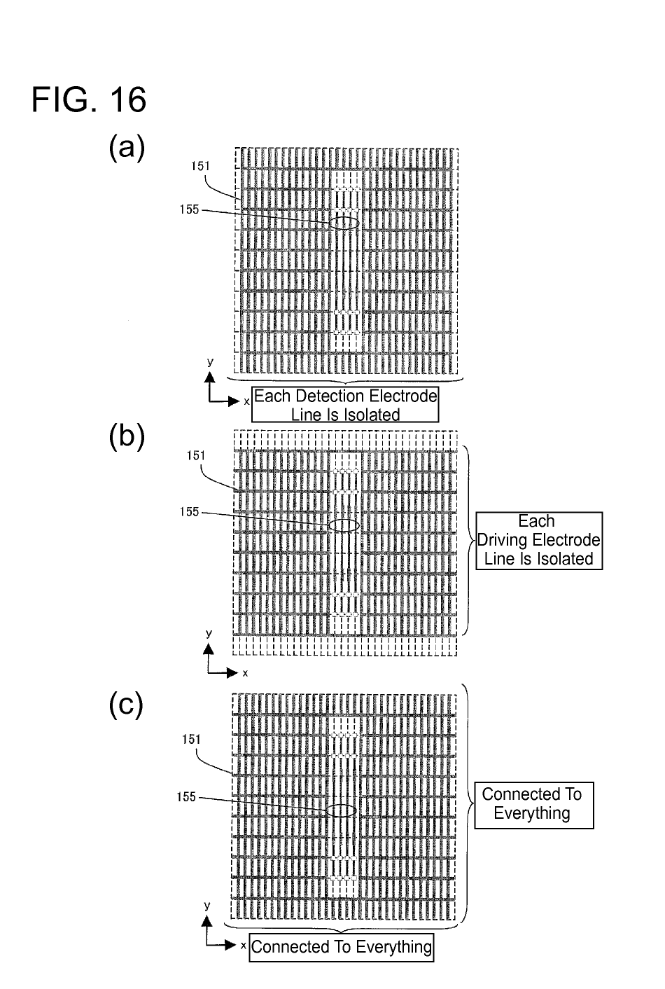

FIG. 16 shows three modification examples of the floating electrodes 151.

The floating electrodes 151 shown in FIG. 16(a) are formed isolated for each line of the detection electrodes 131. In other words, the floating electrodes 151 are electrically connected in the Y axis direction (vertical direction in the drawing) in which the detection electrodes 131 are connected, but insulated from the detection electrodes 131 in the width direction in the X axis direction (horizontal direction in the drawing).

In the modification example shown in FIG. 16(b), the floating electrodes 151 are formed isolated for each driving electrode line. In other words, the floating electrodes 151 are electrically connected in the X axis direction (horizontal direction in the drawing), which is the direction in which the driving electrodes 132 are connected, and insulated in the width direction of the driving electrodes 132 in the Y axis direction (vertical direction in the drawing).

In the modification example shown in FIG. 16(c), the floating electrodes 151 are connected to the entire surface of the touch panel component 40. In other words, the floating electrodes 151 are electrically connected in the X axis direction (vertical direction in the drawing), which is the direction in which the detection electrodes 131 are connected, and also connected in the X axis direction (horizontal direction in the drawings), which is the direction in which the driving electrodes 132 are connected.

The floating electrodes 151 shown in FIGS. 16(a), 16(b), and 16(c) can suppress coupling of the driving electrodes 132 and the liquid crystal common electrode 24 of the liquid crystal display component 20 (see FIG. 2(b) and FIG. 3); thus, detection signal degradation can be suppressed when this configuration is used in a touch panel. This means that even if the detection electrodes and the driving electrodes that are mesh-shaped and have a reduction of capacitor components are used, touch location detection that is sufficiently sensitive can be performed, and thus, this makes it possible to realize a touch panel that can have a larger surface area. As already described, forming the detection electrodes, driving electrodes, and floating electrodes from a metal film will make it possible to reduce the time constant of the circuits.

### Embodiment 3

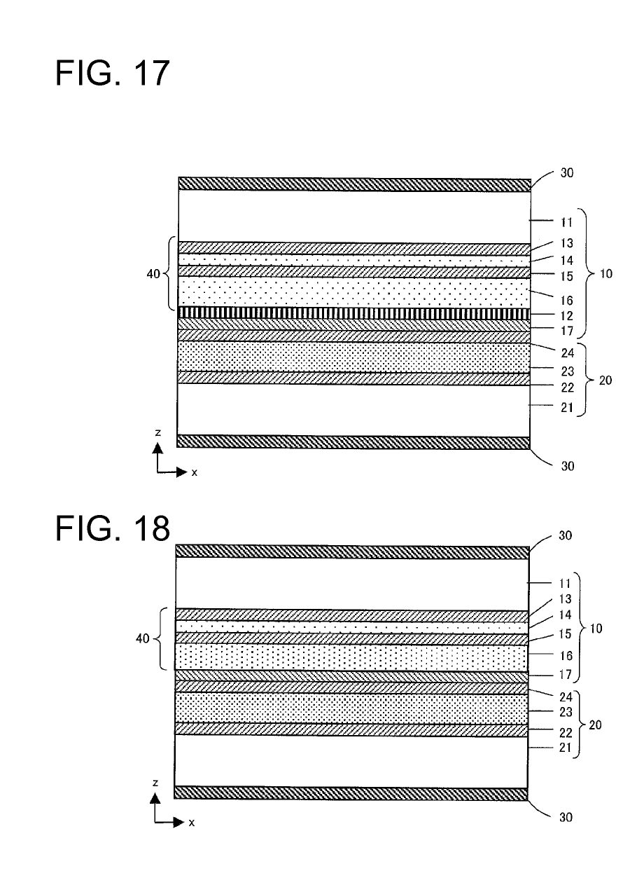

FIG. 17 is a cross-sectional view for explaining Embodiment 3, which is related to a color filter-integrated touch panel of the present invention, and shows a liquid crystal display device in which the color filter-integrated touch panel according to Embodiment 3 of the present invention has been integrated with a liquid crystal display component. In Embodiment 3, only the cross-sectional structure is different from Embodiments 1 and 2, and the same configurations can be used for detection electrodes 131, driving electrodes 132, floating electrodes 151, and the like as those configurations used in Embodiments 1 and 2. In FIG. 17, the same reference characters are given to members that are the same as Embodiment 1 shown in FIG. 3, and a detailed explanation thereof will not be repeated.

In Embodiment 3, in a manner similar to Embodiment 1, the detection electrodes 131 and the driving electrodes 132 are constituted of a 0.2 μm metal film formed in a first mesh layer 13, and the floating electrodes 151 and detection electrode metal bridges 155 are constituted of a 0.2 μm metal film formed in a second mesh layer 15. A Ti film, a three-layer film of Ti/Al/Ti, a two-layer film of Mo/Al, or the like can be used as the metal film, for example. The thickness of a first insulating layer 14 is 2 μm and the thickness of a second insulating layer 16 is 4 μm.

In Embodiment 3 shown in FIG. 17, the position of a black matrix 12 is different from Embodiments 1 and 2. In Embodiments 1 and 2, the black matrix 12 is formed on the color filter glass substrate 11 which is on the viewer's side, but in Embodiment 3, the black matrix 12 is on a touch panel component 40, and disposed on the liquid crystal display device side (in other words, the position close to a display component 20 side). Specifically, in Embodiment 3, the black matrix 12 is formed between the touch panel component 40 and a color filter 17. In this case, the black matrix 12 is formed corresponding to the respective edges of the sub-pixels in the display device, which is similar to Embodiments 1 and 2.

With this configuration, the distance between the touch panel component 40 and a liquid crystal common electrode 20 of the liquid crystal display component 20 becomes longer, which can more efficiently block signal degradation and prompt further improvement in detection sensitivity of touch location detection.

### Embodiment 4

FIG. 18 shows Embodiment 4, which is related to a color filter-integrated touch panel of the present invention, and shows a liquid crystal display device in which the color filter-integrated touch panel according to Embodiment 4 of the present invention has been integrated with a liquid crystal display component. In Embodiment 4, only the cross-sectional structure is different from Embodiments 1, 2, and 3, and the same configurations can be used for detection electrodes 131, driving electrodes 132, floating electrodes 151, and the like as those configurations used in Embodiments 1 and 2. In FIG. 18, the same reference characters are given to members that are the same as Embodiment 3 shown in FIGS. 3 and 17, and a detailed explanation thereof will not be repeated.

In Embodiment 4, the black matrix 12 is omitted from the color filter-integrated touch panel shown in Embodiments 1, 2, and 3. The floating electrodes 151 and detection electrode metal bridges 155 disposed in a second mesh layer 15 have the black matrix functions instead. In order for the floating electrodes 151 and the detection electrode metal bridges 155 to function as a black matrix, it is necessary to cover the respective edges of the sub-pixels in each pixel as much as possible. In this case, it is preferable that a conductive material with a large light-shielding effect be used for the floating electrodes 151 and the detection electrode metal bridges, such as metallic chromium, titanium, nickel, or the like.

The inventors of the present invention and others have confirmed that in order for the floating electrodes 151 and the detection electrode metal bridges 155 to function as a black matrix, the floating electrodes 151 and the detection electrode metal bridges 155 should be separated from each other at a distance of at most one mesh or less. In this case, “mesh” means the same “mesh” formed by the detection electrodes 131, the driving electrodes 132, the floating electrodes 151, and the like, and is the same meshes as those that are demarcated by the sub-pixels in the display device that will be used after being combined with the color filter-integrated touch panel of the present invention.

Even if the display device is formed by using the color filter-integrated touch panel having this configuration, a display quality that in practice has no particular short-comings can be achieved. According to Embodiment 4, it is not necessary to have a separately provided black matrix, thereby simplifying the process of manufacturing the color filter-integrated touch panel. Due to this, fewer materials are required, and costs can be suppressed. In other words, even if the black matrix is omitted, the floating electrodes and the detection electrode metal bridges, which have the smallest disconnection possible, function in a manner similar to the black matrix. This reduces costs, while making it possible to provide a color filter-integrated touch panel suitable for a large-screen display device.

### Embodiment 5

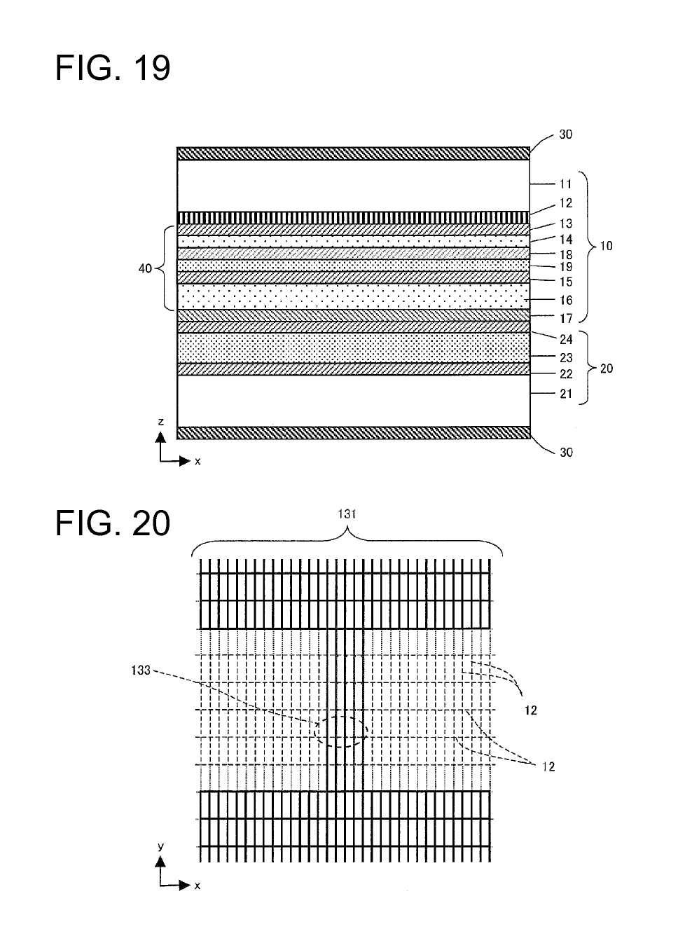

FIGS. 19 to 23 are views of Embodiment 5, which is related to a color filter-integrated touch panel of the present invention, and show a liquid crystal display device in which the color filter-integrated touch panel according to Embodiment 5 of the present invention has been integrated with a liquid crystal display component.

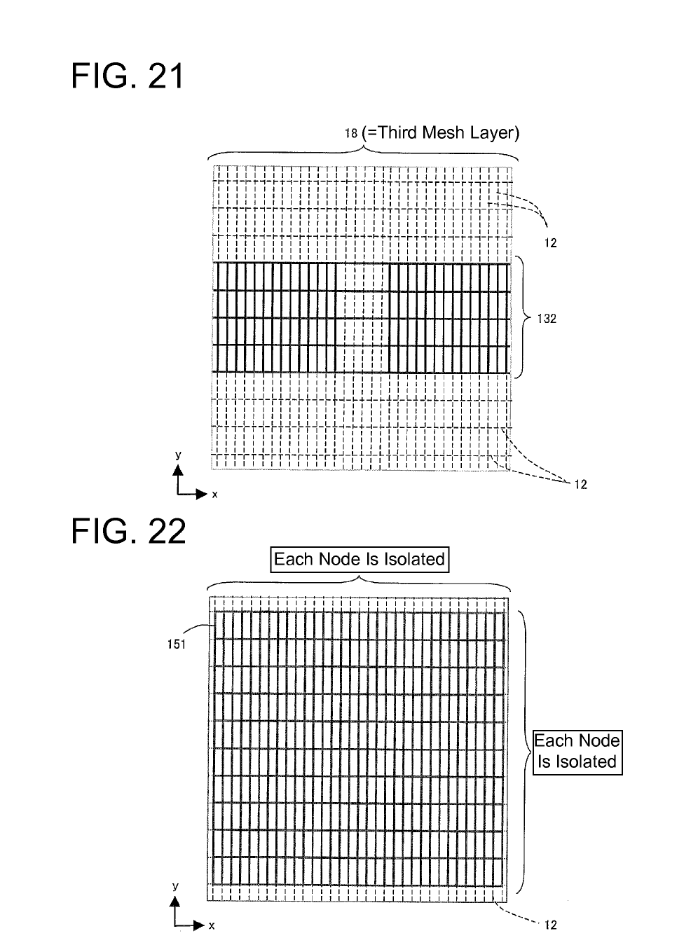

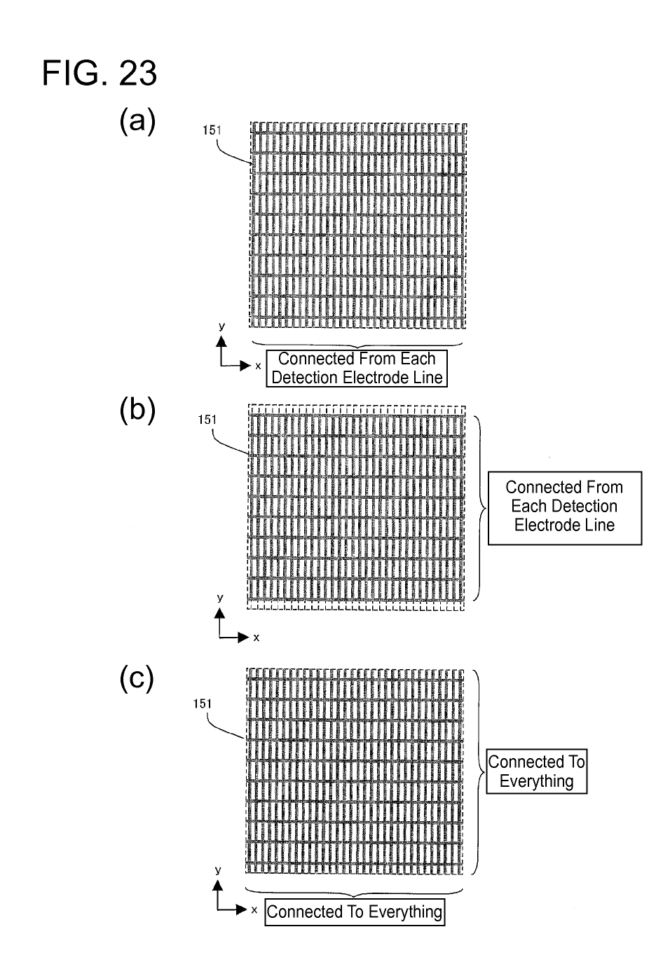

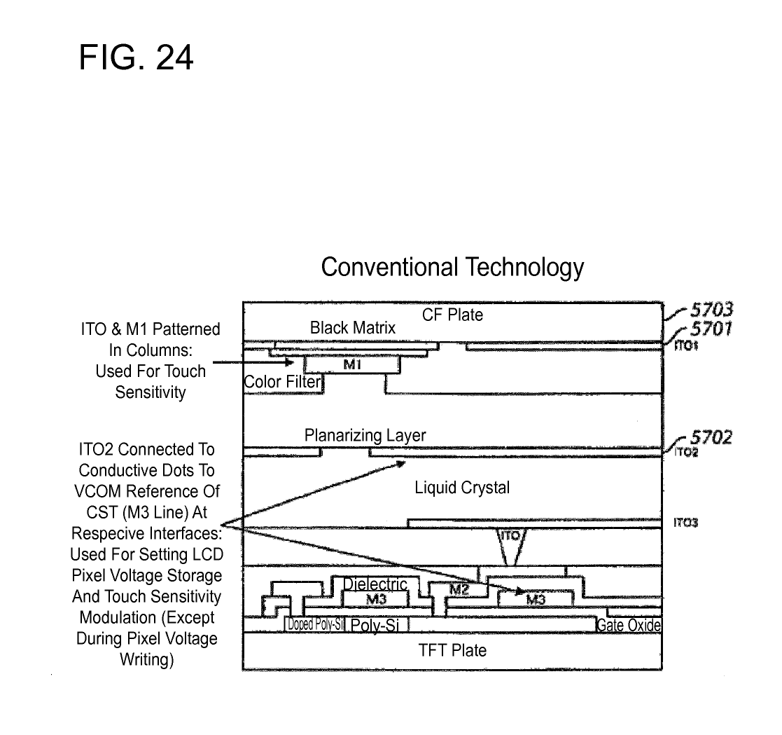

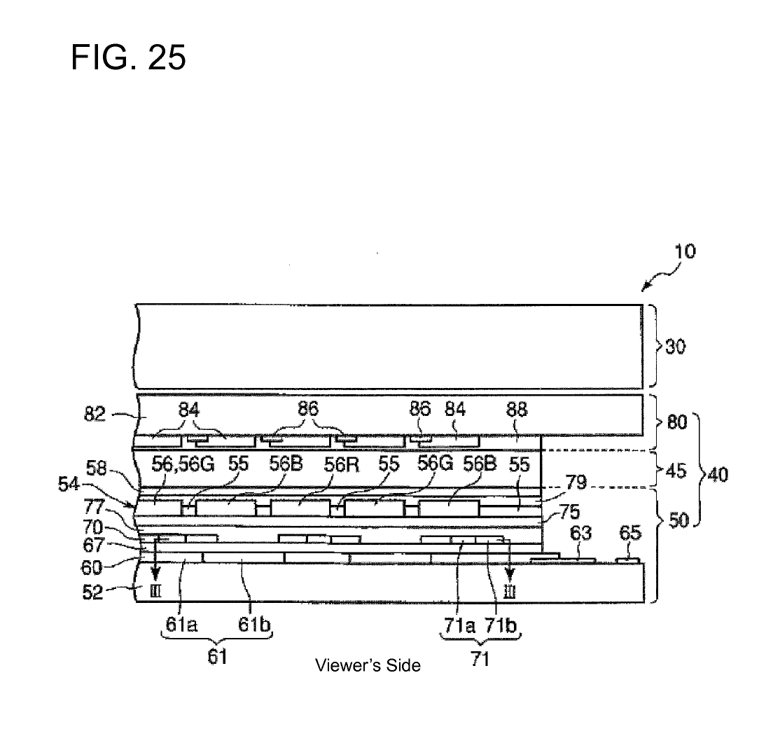

FIG. 19 shows a cross-sectional structure of a liquid crystal display device that is formed by combining a color filter-integrated touch panel 10 according to Embodiment 5 of the present invention with a liquid crystal display component 20. FIG. 20 shows the configuration of detection electrodes 131, which are one constituting component of a touch panel component 40, and FIG. 21 shows the configuration of driving electrodes 132 of the touch panel component 40. FIG. 22 shows one example of floating electrodes 155, and FIG. 23 shows three modification examples of the floating electrodes 151.

In Embodiment 5, a third mesh layer 18 and a third insulating layer 19 are further formed between the first insulating layer 14 and the second mesh layer 15 shown in Embodiments 1 to 4. Namely, the touch panel component 40 is constituted of the first mesh layer 13, the first insulating layer 14, the second mesh layer 15, the second insulating layer 16, and the newly provided third mesh layer 18 and the third insulating layer 19. As shown in FIG. 19, the third mesh layer and the third insulating layer 19 are interposed between the first insulating layer 14 and the second mesh layer 15.

In Embodiment 5, the floating electrodes 151 are constituted of a metal film formed in the second mesh layer 15, in a manner similar to Embodiments 1 to 4, but the detection electrodes 131 are constituted of a metal film formed in the first mesh layer 13, and the driving electrodes 132 are constituted of a metal film formed in the newly provided third mesh layer 18. Accordingly, only the detection electrodes are formed in the first mesh layer 13, only the floating electrodes 151 are formed in the second mesh layer 15, and only the driving electrodes 132 are formed in the third mesh layer 18.

FIG. 20 shows an example of the detection electrodes 131 provided in the first mesh layer 13. This detection electrodes 131 have substantially the same form as the detection electrodes described in FIGS. 4 to 6, but the top area and the bottom area in the drawing in the same first mesh layer 13 are connected by bridges. A black matrix 12 is shown in FIG. 20.

The newly interposed third mesh layer 18 is shown in FIG. 21. As is clear from FIG. 21, the driving electrodes 132 are formed in this third mesh layer 18. The driving electrodes 132 are the same shape as the driving electrodes 132 of Embodiment 1 described in FIGS. 4 to 6, but face the respective detection electrodes 131 through the first insulating layer 14. Touch location of a fingertip or the like is detected by these driving electrodes 132 and detection electrodes 131. A black matrix 12 is shown in FIG. 20.

FIG. 22 shows an example of the floating electrodes 151 provided in the second mesh layer 15. The floating electrodes 151 shown in FIG. 22 have the same basic principles as the floating electrodes described in FIGS. 7 and 15 and are electrically insulated for each one node area 135. However, there is no need to provide detection electrode metal bridges in the second mesh layer 15, and thus, the floating electrodes 151 takes a simpler mesh electrode shape in the one node area.

In Embodiment 5, the first mesh layer 13, the second mesh layer 15, and the newly provided third mesh layer 18 are all constituted of a 0.2 μm metal film, and the first insulating film 14 and the newly provided third insulating layer both have a thickness of 2 μm, and the second insulating layer has a thickness of 4 μm. A Ti film, a three-layer film of Ti/Al/Ti, a two-layer film of Mo/Al, or the like can be used as the metal film, for example.

FIG. 23 shows three modification examples of the floating electrodes 151. These modification examples have the same basic principles as Embodiments 1 and 2, but there is no need to provide detection electrode metal bridges in the second mesh layer 15, and thus, the floating electrodes are shaped to be simpler mesh electrodes.

The floating electrodes 151 shown in FIG. 23(a) are formed isolated for each line of the detection electrodes 131. In other words, the floating electrodes 151 are electrically connected in the Y axis direction (vertical direction in the drawing) in which the detection electrodes 131 are connected, but insulated from the detection electrodes 131 in the width direction in the X axis direction (horizontal direction in the drawing).

In the modification example shown in FIG. 23(b), the floating electrodes 151 are formed isolated for each driving electrode line. In other words, the floating electrodes 151 are electrically connected in the X axis direction (horizontal direction in the drawing), which is the direction in which the driving electrodes 132 are connected, and insulated in the width direction of the driving electrodes 132 in the Y axis direction (vertical direction in the drawing).

In the modification example shown in FIG. 23(c), the floating electrodes 151 are connected to the entire surface of the touch panel component 40. In other words, the floating electrodes 151 are electrically connected in the X axis direction (vertical direction in the drawing), which is the direction in which the detection electrodes 131 are connected, and also connected in the X axis direction (horizontal direction in the drawings), which is the direction in which the driving electrodes 132 are connected.

The floating electrodes 151 shown in FIGS. 23(a), 23(b), and 23(c) can suppress coupling of the driving electrodes 132 and the liquid crystal common electrode 24 of the liquid crystal display component 20 (see FIG. 2(b) and FIG. 3); thus, detection signal degradation can be suppressed when this configuration is used in a touch panel. This means that even if the detection electrodes and the driving electrodes that are mesh-shaped and have a reduction of capacitor components are used, touch location detection that is sufficiently sensitive can be performed, and thus, this makes it possible to realize a touch panel that can have a larger surface area. As already described, forming the detection electrodes, driving electrodes, and floating electrodes from a metal film with even higher conductivity will make it possible to reduce the time constant of the circuits.

When forming just the floating electrodes 151 in the second mesh layer 15, the disconnection portion of the floating electrodes 151 can be made very small, and in particular, in configurations where the floating electrodes 151 shown in FIG. 23(c) are formed over the entire surface, the floating electrodes 151 can be made to effectively have a black matrix function.

In Embodiment 5 described above, the basic shape of the detection electrodes 131 and the driving electrodes 132 is rectangular, but it goes without saying that the diamond-shaped detection electrodes and driving electrodes shown in FIG. 11 can also satisfy the principles in Embodiment 5 for the detection electrodes 131 and the driving electrodes 132.

### INDUSTRIAL APPLICABILITY

The present invention provides a color filter-integrated touch panel with a large surface area, can be applied to the entire surface of a large-screen display device, and can minimize degradation of display quality. The present invention has high industrial applicability.

### DESCRIPTION OF REFERENCE CHARACTERS

10 color filter-integrated touch panel
11 color filter glass substrate
12 black matrix
13 first mesh layer
131 detection electrode
1310 mesh of detection electrode
1311 rectangular electrode formed from a plurality of meshes (detection electrode)
1312 diamond-shaped electrode formed from a plurality of meshes (detection electrode)
132 driving electrode
1320 mesh of driving electrode
1321 rectangular electrode formed from a plurality of meshes (driving electrode)
1322 diamond-shaped electrode formed from a plurality of meshes (driving electrode)
133 bridge
135 one node area
14 first insulating layer
15 second mesh layer
151 floating electrode
155 detection electrode metal bridge
156 contact hole
16 second insulating layer
17 color filter
18 third mesh layer
19 third insulating layer
20 liquid crystal display component
21 glass substrate
22 liquid crystal driving electrode
23 liquid crystal layer
24 liquid crystal common electrode
40 touch panel component

1. A color filter-integrated touch panel, comprising:
a substrate;
a touch panel component having detection electrodes and driving electrodes for touch location detection disposed on the substrate; and
a color filter formed on the touch panel component,
wherein the detection electrodes and the driving electrodes of the touch panel component are insulated from each other and are mesh-shaped electrodes formed from a plurality of meshes,
wherein mesh-shaped floating electrodes formed from a plurality of meshes are disposed between the color filter and the touch panel component having the detection electrodes and the driving electrodes, the floating electrodes being electrically insulated from said detection electrodes and said driving electrodes, and
wherein each of the floating electrodes centers around the driving electrodes and respectively overlaps the driving electrode and the detection electrodes adjacent thereto.

2. The color filter-integrated touch panel according to claim 1, further comprising:
a light-shielding member formed on the color filter close to a viewer at positions corresponding to respective edges of the meshes of the detection electrodes, the driving electrodes, and the floating electrodes.

3. The color filter-integrated touch panel according to claim 2,
wherein the light-shielding member is formed at respective edges of sub-pixels, and
wherein the meshes of the detection electrodes and the driving electrodes forming the touch panel component and the meshes of the floating electrodes are formed at the respective edges of the sub-pixels.

4. The color filter-integrated touch panel according to claim 1,
wherein the detection electrodes and the driving electrodes of the touch panel component are made of a metal film formed in a first mesh layer, and
wherein the floating electrodes are made of a metal film formed in a second mesh layer that is different from the first mesh layer.

5. The color filter-integrated touch panel according to claim 1,
wherein the detection electrodes are rectangular electrodes formed from the plurality of meshes that extend in an X axis direction and a Y axis direction, a plurality of said detection electrodes being electrically connected in the Y axis direction, and
wherein the driving electrodes are rectangular electrodes formed from the plurality of meshes that extend in the X axis direction and the Y axis direction, a plurality of said driving electrodes being electrically connected in the X axis direction.

6. The color filter-integrated touch panel according to claim 1,
wherein the detection electrodes are diamond-shaped electrodes formed from the plurality of meshes that extend in an X axis direction and a Y axis direction, a plurality of said detection electrodes being electrically connected in the Y axis direction, and
wherein the driving electrodes are diamond-shaped electrodes formed from the plurality of meshes that extend in the X axis direction and the Y axis direction, a plurality of said driving electrodes being electrically connected in the X axis direction.

7. The color filter-integrated touch panel according to claim 2, wherein the touch panel component having the detection electrodes and the driving electrodes is formed under the light-shielding member as seen by a viewer.

8. The color filter-integrated touch panel according to claim 4, further comprising:
detection electrode metal bridges for connecting at least some of the detection electrodes together, the detection electrode metal bridges being formed in the second mesh layer,
wherein the floating electrodes and the detection electrode metal bridges are separated from each other at a distance corresponding to at most one mesh, and
wherein the floating electrodes and the detection electrode metal bridges have a light-shielding function.

9. The color filter-integrated touch panel according to claim 1,
wherein the detection electrodes of the touch panel component are made of a metal film formed in a first mesh layer,
wherein the floating electrodes are made of a metal film formed in a second mesh layer that is different from the first mesh layer, and
wherein the driving electrodes are made of a third mesh layer that is disposed between the first mesh layer and the second mesh layer.

10. The color filter-integrated touch panel according to claim 9,
wherein the floating electrodes formed in the second mesh layer are separated from each other at a distance corresponding to at most one mesh, and
wherein the floating electrodes have a light-blocking function.

11. The color filter-integrated touch panel according to claim 1, wherein the floating electrodes are electrically insulated in each one node area that is a smallest unit for touch location detection.

12. The color filter-integrated touch panel according to claim 1, wherein the floating electrodes are electrically connected from each line of the detection electrodes.

13. The color filter-integrated touch panel according to claim 1, wherein the floating electrodes are electrically connected from each line of the driving electrodes.

14. The color filter-integrated touch panel according to claim 1, wherein the floating electrodes constitute a single unitary electrode formed from a plurality of meshes extending over an entire surface of the touch panel component.

15. A liquid crystal display device, comprising:
the color filter-integrated touch panel according to claim 1.

16. A plasma display device, comprising:
the color filter-integrated touch panel according to claim 1.

17. An electroluminescent display device, comprising:
the color filter-integrated touch panel according to claim 1.
